(19) United States
(12) Patent Application Publication
(10) Pub. No.: US 2007/0022888 A1
(43) Pub. Date: Feb. 1, 2007

(54) Ink supply amount adjustment method and apparatus for printing press

(75) Inventors: Akihiro Inde, Ibaraki (JP); Masahiro Hirano, Ibaraki (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Komori Corporation

(21) Appl. No.: 11/489,090

(22) Filed: Jul. 17, 2006

(30) Foreign Application Priority Data
Jul. 27, 2005 (JP) 217176/2005

(51) Int. Cl. B41F 31/02

(52) U.S. Cl. 101/365

(57) ABSTRACT

In an ink supply amount adjustment method, a density value of a printed paper sheet is measured. The ink fountain key opening ratio is corrected on the basis of a difference between the measured density value of the printed paper sheet and a preset reference density value. The ink feed operation of the ink ductor roller is performed without printing after correction of the ink fountain key opening ratio to increase or decrease the amount of ink on the ink rollers.

### BACKGROUND OF THE INVENTION

The present invention relates to an ink supply amount adjustment method and apparatus for a printing press, which adjusts the ink supply amount to a printing plate by adjusting the opening ratio of an ink fountain key.

Generally, a rotary printing press includes a plurality of color printing units, and each color printing unit includes an inking device (inker). Referring to FIG. 12, the inking device comprises an ink fountain 1, ink 2 stored in the ink fountain 1, an ink fountain roller 3, a plurality of ink fountain keys 4-1 to 4-n juxtaposed in the axial direction of the ink fountain roller 3, an ink ductor roller 5, ink rollers 6, and a plate cylinder 8 on which a printing plate 7 is mounted. An image is printed on the printing plate 7.

In this inking device, the ink 2 in the ink fountain 1 is supplied to the ink fountain roller 3 through the gap between the ink fountain keys 4-1 to 4-n and the ink fountain roller 3. The ink supplied to the ink fountain roller 3 is supplied to the printing plate 7 through the ink rollers 6 by the ink feed operation of the ink ductor roller 5. The ink supplied to the printing plate 7 is printed on a printing paper sheet through a blanket cylinder (not shown).

FIG. 13 shows a printing product printed by this printing press. A band-shaped color bar 9-2 is printed on the margin portion of a printing product 9 except an image region 9-1. In general four-color printing, the color bar 9-2 includes regions S1 to Sn including density measurement patches (solid patches at a percent dot area of 100%) 9a1, 9a2, 9a3, and 9a4 of black, cyan, magenta, and yellow. The regions S1 to Sn correspond to the key zones of ink fountain keys 4-1 to 4-n in each color printing unit of the printing press.

[Color Matching]

A reference density value is set in advance of each color printing unit. More specifically, a reference density value is set in advance for each of black, cyan, magenta, and yellow. In printing the printing product 9, a color matching operation is done to make the density value of each color coincide with the reference density value. This color matching operation is executed by the ink supply amount adjustment apparatus in test printing, proof printing, or the like on the basis of the density of a density measurement patch 9a (9a1, 9a2, 9a3, or 9a4) of each color in the color bar 9-2 printed on the printing product 9.

For example, the region S1 in the printing product 9 will be described as a representative. The density value of the density measurement patch 9a of each color on the printing product 9, which is extracted in test printing, proof printing, or the like, is measured. The difference between the measured density value of each color and the preset reference density value of each color is obtained. The correction amount of the opening ratio of the ink fountain key 4-1 (the correction amount of ink supply amount to the region S1) in each color printing unit is obtained from the obtained density difference of each color. The obtained correction amount is fed back to adjust the opening ratio of the ink fountain key 4-1 in each color printing unit.

In a similar way, for regions S2 to Sn as well, the correction amounts of the opening ratios of the ink fountain keys 4-2 to 4-n (the correction amounts of ink supply amounts to the regions S2 to Sn) in each color printing unit are obtained. The obtained correction amounts are fed back to adjust the opening ratios of the ink fountain keys 4-2 to 4-n in each color printing unit. When the opening ratios of the ink fountain keys 4-1 to 4-n are adjusted, test printing, proof printing, or the like is immediately restarted to repeat the same operation until the density value of each color reaches the reference density value (see Japanese Patent Laid-Open No. 2003-118077).

In the conventional ink supply amount adjustment method described above, an ink transfer path (a transfer path from the ink fountain roller to the blanket cylinder) is long. Hence, in order to adjust the ink supply amount for a printing product, printing on about one hundred printing paper sheets is required from when the ink supply amount is adjusted until the adjusted ink supply amount is reflected on the printing product to obtain a stable corrected density.

Especially, in proof printing to obtain some printing products which are normally printed, it takes a very long time, and the amount of wasted paper increases to obtain some printing products which are normally printed.

To cope with this problem, the present applicant increases the correction amount of an ink fountain key opening ratio (the ink fountain key opening ratio increases when the correction amount has a positive value, and decreases when the correction amount has a negative value) in proof printing to largely change the density of the printing product. Printing is performed while the density of the printing product changes, i.e., before the density of the printing product becomes stable. A printed product with an appropriate density is selected from the printed products to perform proof printing.

However, in this method, proof printing must be restarted when a required number of printed products cannot be obtained by proof printing. In this case, since the ink supply amount is increased/decreased more largely than usual, the obtained density of the printed product largely differs from the normal density, and becomes stable. Hence, the same operation must be repeated. It takes a long time, and the amount of wasted print material increases.

As another method, a “pre-inking (+)” disclosed in U.S. Pat. No. 5,884,562 is used. In this method, the rotation amount of the ink fountain roller increases by a density difference before starting next test printing to supply an amount of ink corresponding to the shortage in this state. In this method, since the ink is supplied to the entire surface of a paper sheet at the same ratio, the ink supply amount cannot be partially adjusted. Especially, when the area to which the ink is excessively supplied and the area in which an ink shortage occurs are mixed, the ink supply amount cannot be sufficiently adjusted.

### SUMMARY OF THE INVENTION

It is an object of the present invention to provide an ink supply amount adjustment method and apparatus for a printing press, which can adjust an ink supply amount in a short period of time, and decrease the amount of wasted paper.

In order to achieve the above objects according to an aspect of the present invention, there is provided an ink supply amount adjustment method of a printing press including a plurality of ink fountain keys, an ink fountain roller which adjusts a supply amount of ink supplied from an ink fountain in accordance with an opening ratio of each of the ink fountain keys, and an ink ductor roller which supplies the ink supplied to the ink fountain roller to a printing plate through ink rollers by an ink feed operation, comprising the steps of measuring a density value of a printed paper sheet, correcting the opening ratio of the ink fountain key on the basis of a difference between a measured density value of the printed paper sheet and a preset reference density value, and performing the ink feed operation of the ink ductor roller without printing after correction of the opening ratio of the ink fountain key to increase or decrease the amount of ink on the ink rollers.

According to another aspect of the present invention, there is provided an ink supply amount adjustment apparatus of a printing press including a plurality of ink fountain keys, an ink fountain roller which adjusts a supply amount of ink supplied from an ink fountain in accordance with an opening ratio of each of the ink fountain keys, and an ink ductor roller which supplies the ink supplied to the ink fountain roller to a printing plate through ink rollers by an ink feed operation, comprising density value measurement means for measuring a density value of a printed paper sheet, opening ratio correction means for correcting the opening ratio of the ink fountain key on the basis of a difference between a measured density value of the printed paper sheet and a preset reference density value, and ink feed control means for performing the ink feed operation of the ink ductor roller without printing after correction of the opening ratio of the ink fountain key to increase or decrease the amount of ink on the ink rollers.

### BRIEF DESCRIPTION OF THE DRAWINGS

FIG. 1 is a bock diagram of a proof printing control device according to the first embodiment of the present invention;

FIGS. 2A and 2B are views showing the contents of a memory in FIG. 1 in detail;

FIG. 3 is a side view showing how to set a calorimeter shown in FIG. 1;

FIGS. 4A to 4P are flowcharts showing the processing operation of the proof printing control device (CPU) shown in FIG. 1;

FIG. 5 is a block diagram schematically showing the internal arrangement of an ink fountain roller control device;

FIG. 6 is a flowchart showing the processing operation of the ink fountain roller control device;

FIG. 7 is a block diagram showing the schematic arrangement of the ink fountain key control device connected to the proof printing control device shown in FIG. 1;

FIGS. 8A and 8B are flowcharts showing the processing operation of the ink fountain key control device (CPU) shown in FIG. 7;

FIGS. 9A and 9B are flowcharts showing the contents of a memory in a proof printing control device according to the second embodiment of the present invention;

FIGS. 10A to 10E are flowcharts showing the processing operation of the proof printing control device (CPU) according to the second embodiment;

FIGS. 11A and 11B are functional block diagrams of CPUs according to the first and second embodiments, respectively;

FIG. 12 is a view showing the main part of an ink supply apparatus in each color printing unit included in a rotary printing press; and

FIG. 13 is a plan view schematically showing proof printing, and a printing product printed by the printing press.

### DESCRIPTION OF THE PREFERRED EMBODIMENTS

The present invention will be described below in detail with reference to the accompanying drawings.

### First Embodiment

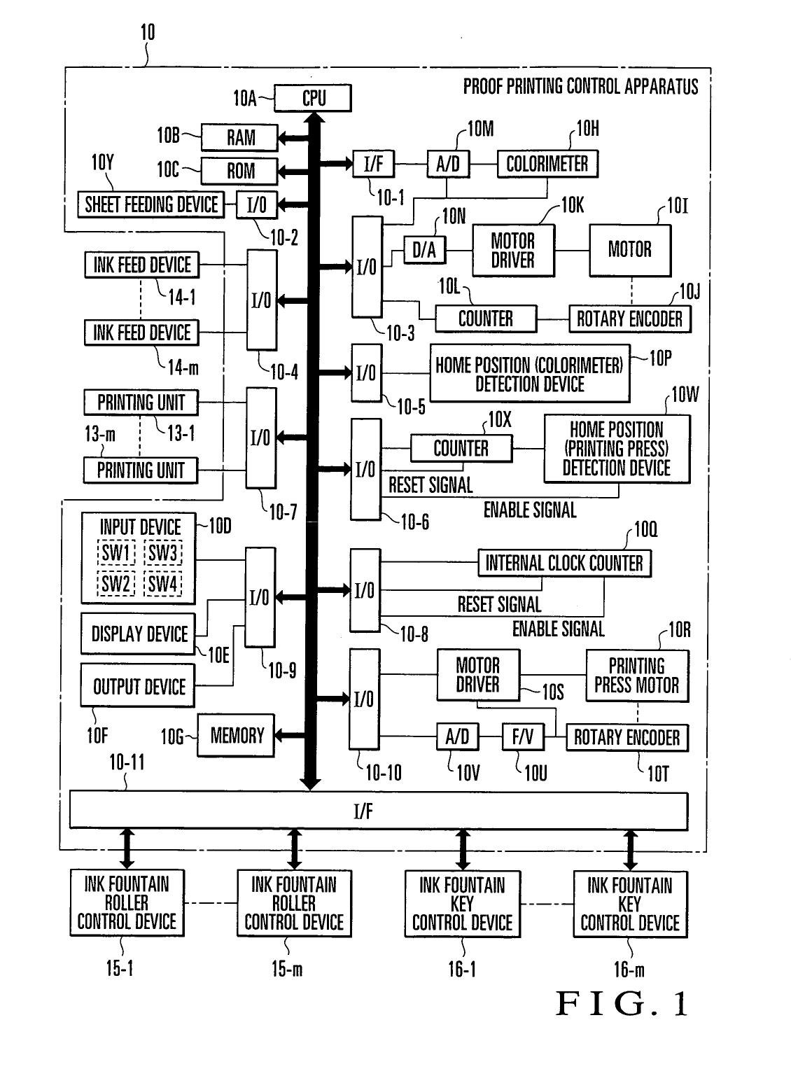

FIG. 1 shows a proof printing control device according to this embodiment of the present invention. A proof printing control device 10 comprises a CPU 10A, a RAM 10B, a ROM 10C, an input device 10D, a display device 10E, an output device 10F, a memory 10G, a colorimeter 10H, a colorimeter moving motor 10I, a rotary encoder 10J for the calorimeter moving motor, a motor driver 10K for moving the colorimeter, a counter 10L for measuring the current position of the colorimeter, an A/D converter 10M, a D/A converter 10N, a detector 10P for detecting the home position of the colorimeter, an internal clock counter 10Q, a driving motor 10R of a printing press, a driver 10S of a printing press driving motor, a rotary encoder 10T for the printing press driving motor, an F/V converter 10U, an A/D converter 10V, a detector 10W for detecting the home position of the printing press, counter 10X for counting total rotational speed of the printing press, a sheet feeding device 10Y, and input/output interfaces (I/O, I/F) 10-1 to 10-11.

The CPU 10A operates in accordance with a program stored in the ROM 10C while obtaining various kinds of input information given through the interfaces 10-1 to 10-11 and accessing the RAM 10B or memory 10G. The input device 10D has a proof printing preset switch SW1, proof printing start switch SW2, proof printing re-preset switch SW3, and control end switch SW4.

The rotary encoder 10J generates a rotation pulse for each predetermined rotational speed (angle) of the colorimeter moving motor 10I, and outputs the pulse to the counter 10L. The rotary encoder 10T generates a rotation pulse for each predetermined rotational speed (angle) of the printing press driving motor 10R, and outputs the pulse to the F/V converter 10U and driving motor driver 10S.

In FIG. 1, reference numerals 13-1 to 13-m denote color printing units; 14-1 to 14-m, ink feed devices; 15-1 to 15-m, ink fountain roller control devices; and 16-1 to 16-n, ink fountain key control devices of the respective colors.

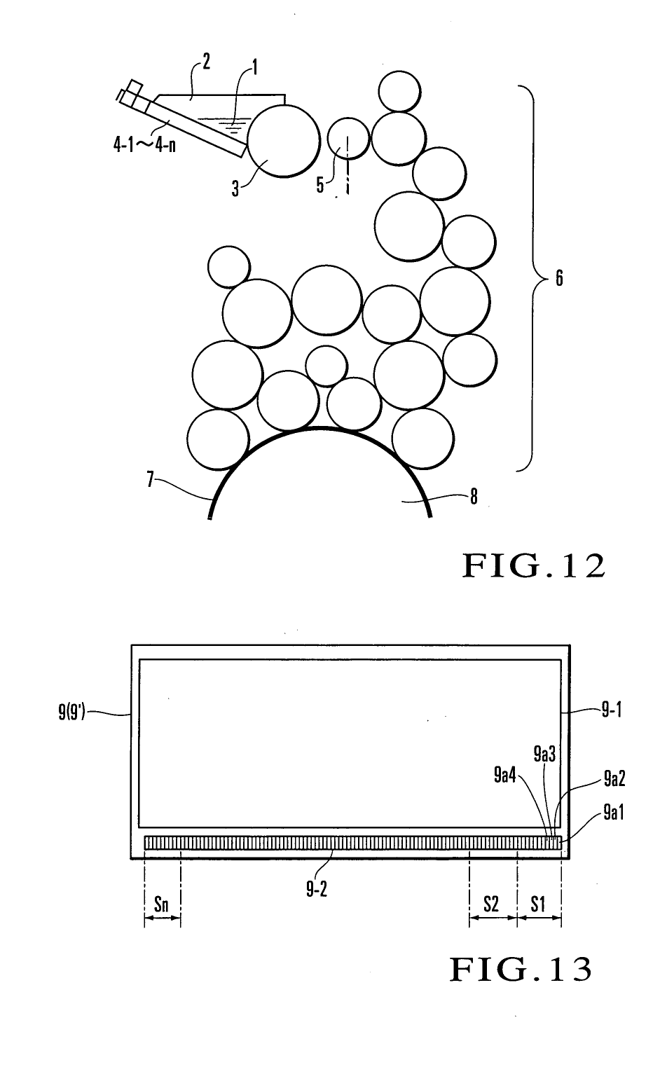

The ink feed devices 14-1 to 14-m are individually provided in correspondence with the color ink ductor rollers 5 of the respective colors shown in FIG. 12. The ink fountain roller control devices 15-1 to 15-m are individually provided in correspondence with the ink fountain rollers 3 of the respective colors shown in FIG. 12. The ink fountain key control devices 16-1 to 16-n are individually provided in correspondence with the ink fountain keys 4-1 to 4-n shown in FIG. 12.

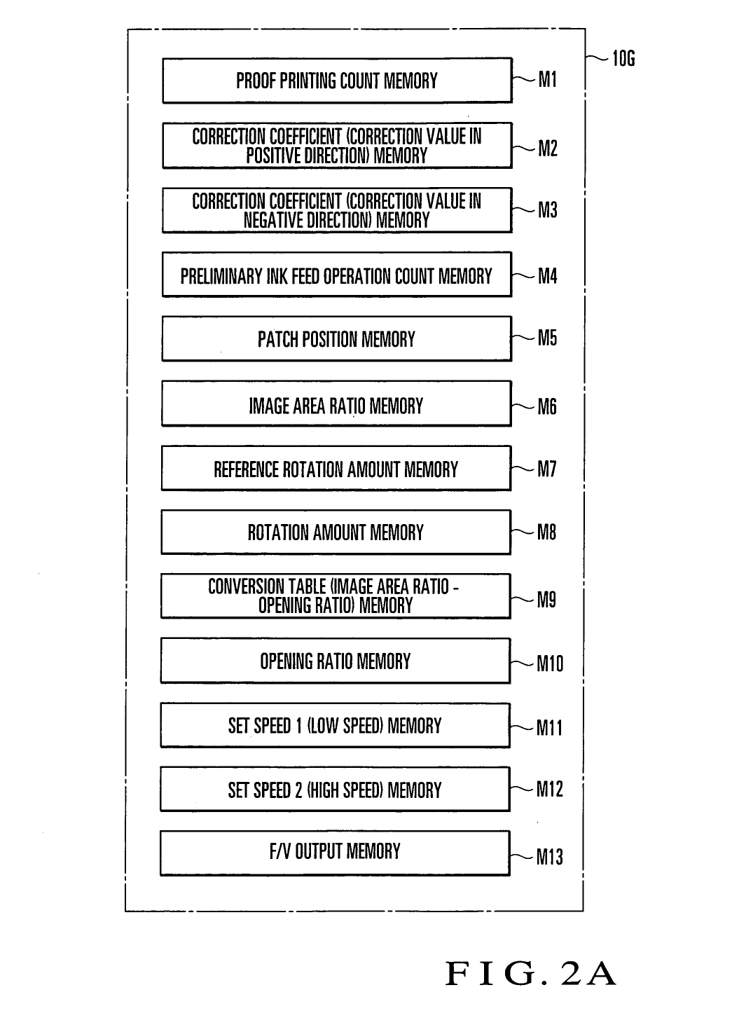

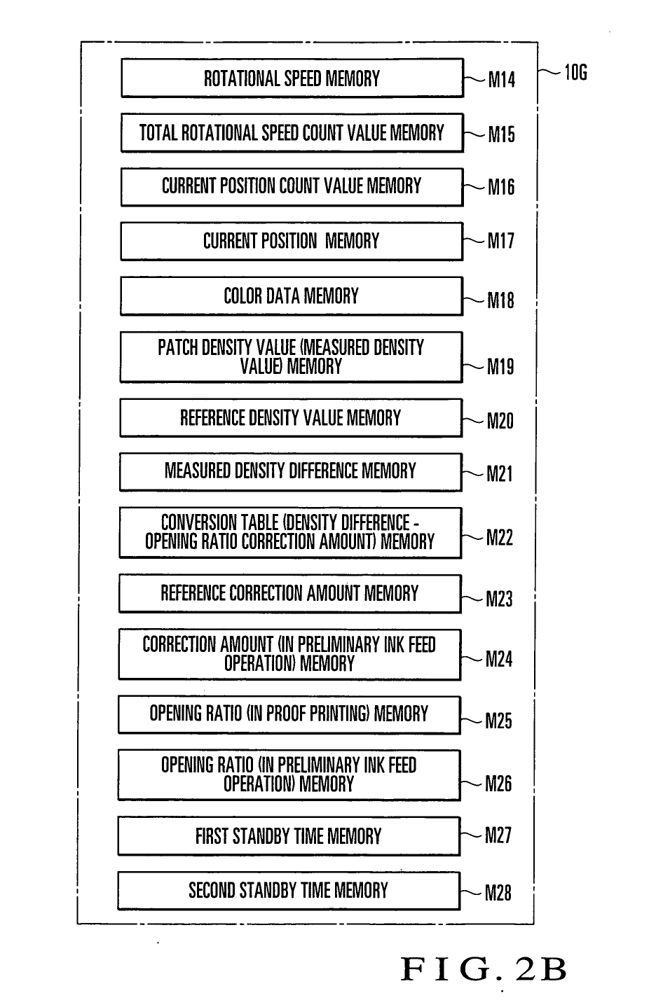

FIGS. 2A and 2B show the contents of the memory 10G. The memory 10G includes memories M1 to M28. The memory M1 stores the number of paper sheets subjected to proof printing. The memory M2 stores a correction coefficient (>1) for a correction value of each color in the positive direction. The memory M3 stores a correction coefficient (>1) for a correction value of each color in the negative direction. The memory M4 stores the number of preliminary ink feed operations of each color. The memory M5 stores the position of each patch of each color in a color bar serving as a proof printing sample to be measured by the colorimeter. The memory M6 stores an image area ratio in a range corresponding to each ink fountain key of each color for proof printing.

The memory M7 stores the reference rotation amount of the ink fountain roller of each color. The memory M8 stores the rotation amount of the ink fountain roller of each color. The memory M9 stores an “image area ratio—ink fountain key opening ratio conversion table” for each color which represents the relationship between the image area ratio and the ink fountain key opening ratio for each color. The memory M10 stores the opening ratio of each ink fountain key. The memory M11 stores a set speed 1 (low speed) of the printing press. The memory M12 stores a set speed 2 (high speed) of the printing press. The memory M13 stores the output from the F/V converter connected to the rotary encoder for the printing press driving motor.

The memory M14 stores the current rotational speed of the printing press. The memory M15 stores the counter value for counting the total rotational speed of the printing press. The memory M16 stores the counter value for measuring the current position of the colorimeter. The memory M17 stores the current position of the calorimeter. The memory M18 stores color data from the colorimeter. The memory M19 stores the density value of the patch of each color serving as a proof printing sample. The memory M20 stores the reference density value of each color in the color bar.

The memory M21 stores a difference (measured density difference) between the reference density value of each color and the density value of each patch of each color serving as a proof printing sample. The memory M22 stores a “density difference—ink fountain key opening ratio correction amount conversion table” for each color which represents the relationship between the density difference and the correction amount of the ink fountain key opening ratio for each color. The memory M23 stores the reference correction amount of the ink fountain key opening ratio of each color. The memory M24 stores the correction amount (actual correction amount) of the ink fountain key opening ratio of each color in a preliminary ink feed operation.

The memory M25 stores the ink fountain key opening ratio of each color in proof printing. The memory M26 stores the ink fountain key opening ratio of each color in the preliminary ink feed operation. The memory M27 stores the count value in the first standby time. The memory M28 stores the count value in the second standby time.

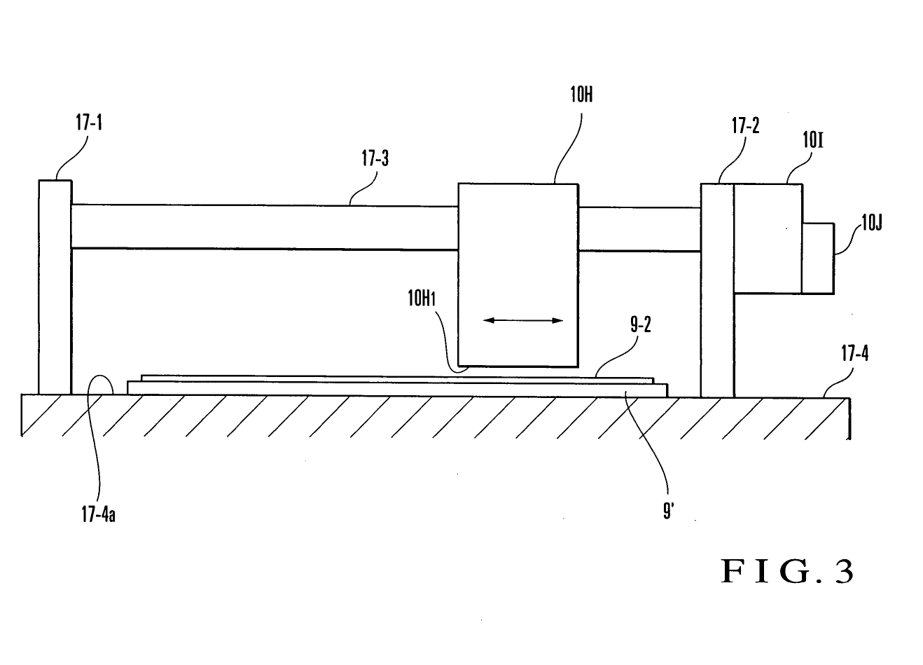

Referring to FIG. 3, the colorimeter 10H is attached to a ball screw (feed screw) 17-3 arranged between columns 17-1 and 17-2. The ball screw 17-3 is rotated in the forward or reverse direction by the calorimeter moving motor 10I. As the ball screw 17-3 rotates in the forward or reverse direction, the calorimeter 10H moves between the columns 17-1 and 17-2 while being guided by the ball screw 17-3. A head portion 10H1 of the colorimeter 10H is directed to a surface 17-4a of a measurement table 17-4 on which an object to be measured is placed.

[Schematic Operation in First Embodiment]

Prior to a detailed description of the operation according to the first embodiment, a schematic sequence will be explained for the sake of easy understanding.

(1) Each data is input.

(2) The proof printing preset switch SW1 is turned on. Each ink fountain key opening ratio is obtained from the input image area ratio to set the obtained ink fountain key opening ratio. Additionally, each ink fountain roller feed rate is set as a reference value.

(3) The rotational speed of the printing press is set to a set speed 1 (low speed).

(4) The proof printing start switch SW2 is turned on. The rotational speed of the printing press is set to the set speed 2 (high speed) to perform proof printing on the set number of printing paper sheets. After that, the rotational speed of the printing press is set to the set speed 1 (low speed).

(5) The proof printing re-preset switch SW3 is turned on. The density of each color patch subjected to proof printing is measured to obtain the difference between the measured density of each color patch and the reference density.

(6) The reference correction amount of the ink fountain key opening ratio and the correction amount in the preliminary ink feed operation are obtained from the obtained density difference.

(7) The reference correction amount is added to the current ink fountain key opening ratio to obtain the ink fountain key opening ratio in proof printing. Additionally, the correction amount (actual correction amount) in the preliminary ink feed operation is added to the current ink fountain key opening ratio to obtain the ink fountain key opening ratio in the preliminary ink feed operation.

(8) The ink fountain roller feed rate is set as a reference value, and the ink fountain key opening ratio is set to the opening ratio in the preliminary ink feed operation which is obtained in (7). The rotational speed of the printing press is set to the set speed 2 (high speed), and the printing press is kept idle for the set first standby time.

(9) The ink feed device operates (the preliminary ink feed operation is performed) a predetermined number of times to supply ink to the inking device of the printing press. After that, the printing press is kept idle for the set second standby time.

(10) The rotational speed of the printing press is set to the set speed 1 (low speed), and the ink fountain key opening ratio is set to the opening ratio in proof printing which is obtained in (7).

(11) The proof printing start switch SW2 is turned on again. The rotational speed of the printing press is set to the set speed 2 (high speed) to perform proof printing on a set number of paper sheets. After that, the rotational speed of the printing press is set to the set speed 1 (low speed).

(12) The operations (5) to (11) are repeated until satisfactory proof printing is performed.

[Detailed Operation of First Embodiment]

[Data Input]

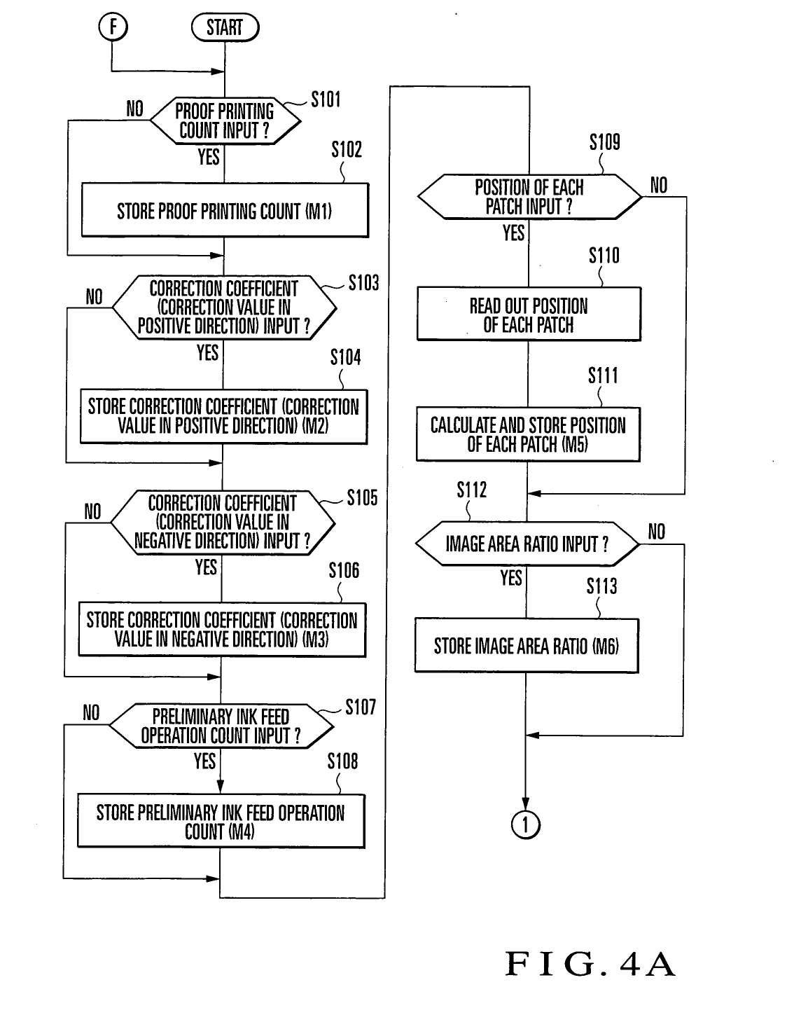

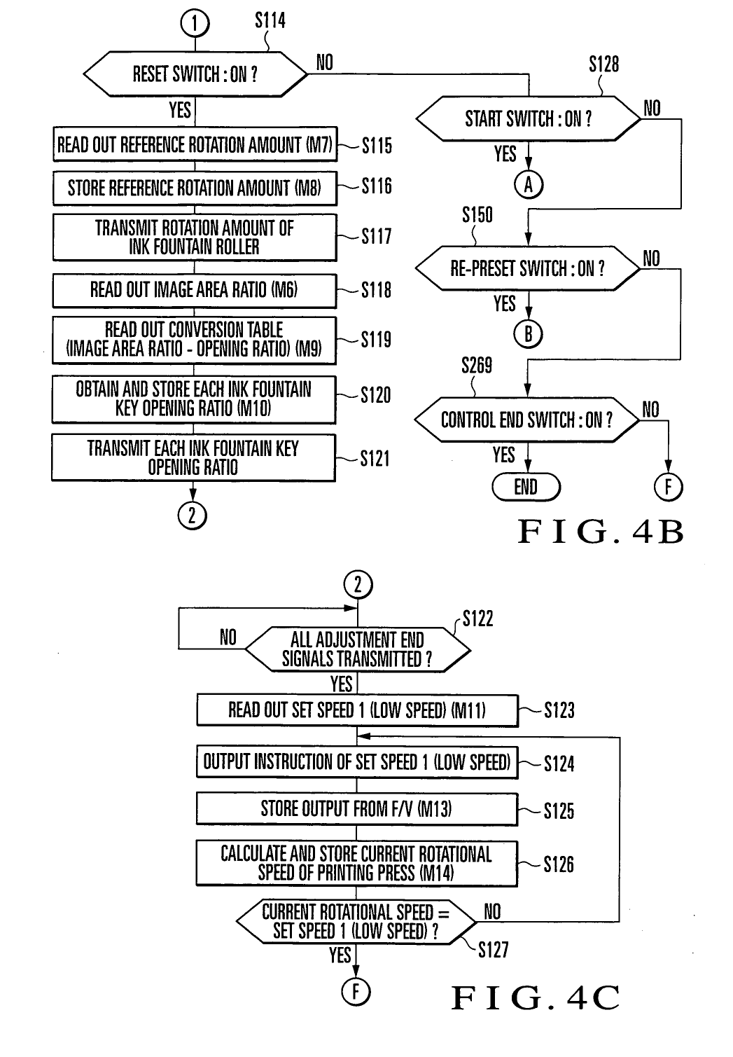

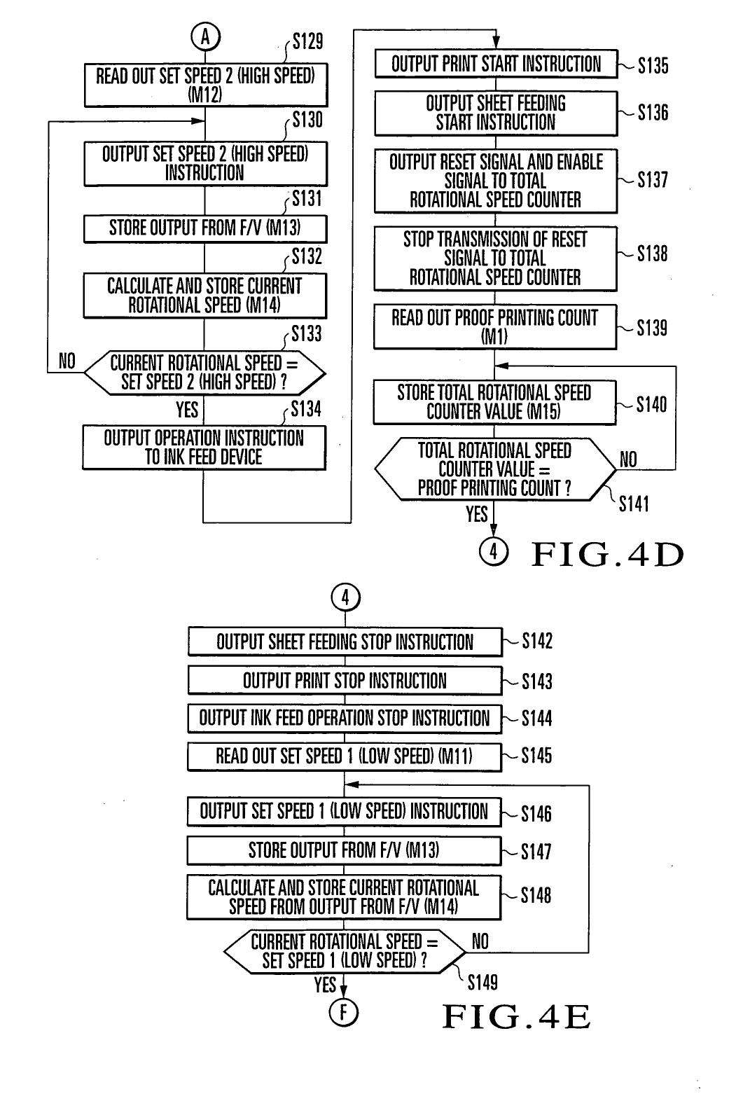

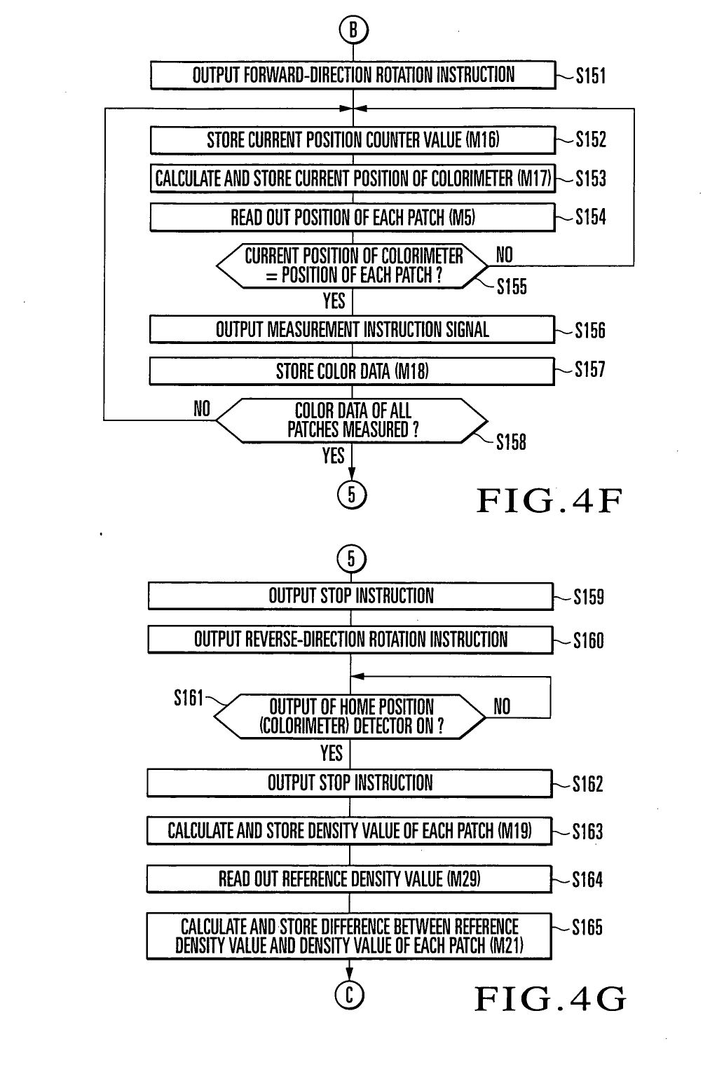

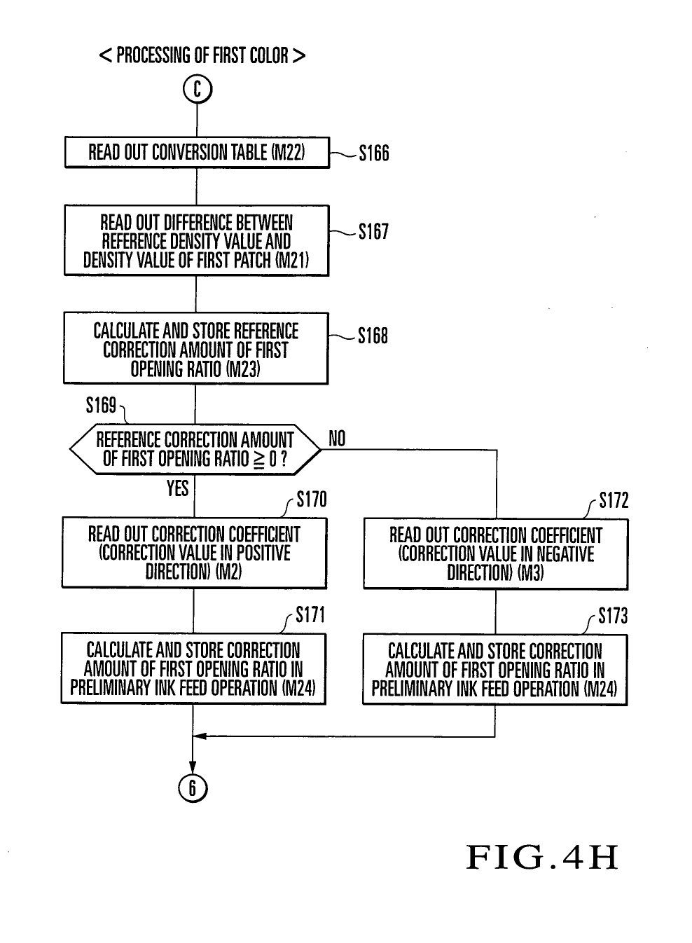

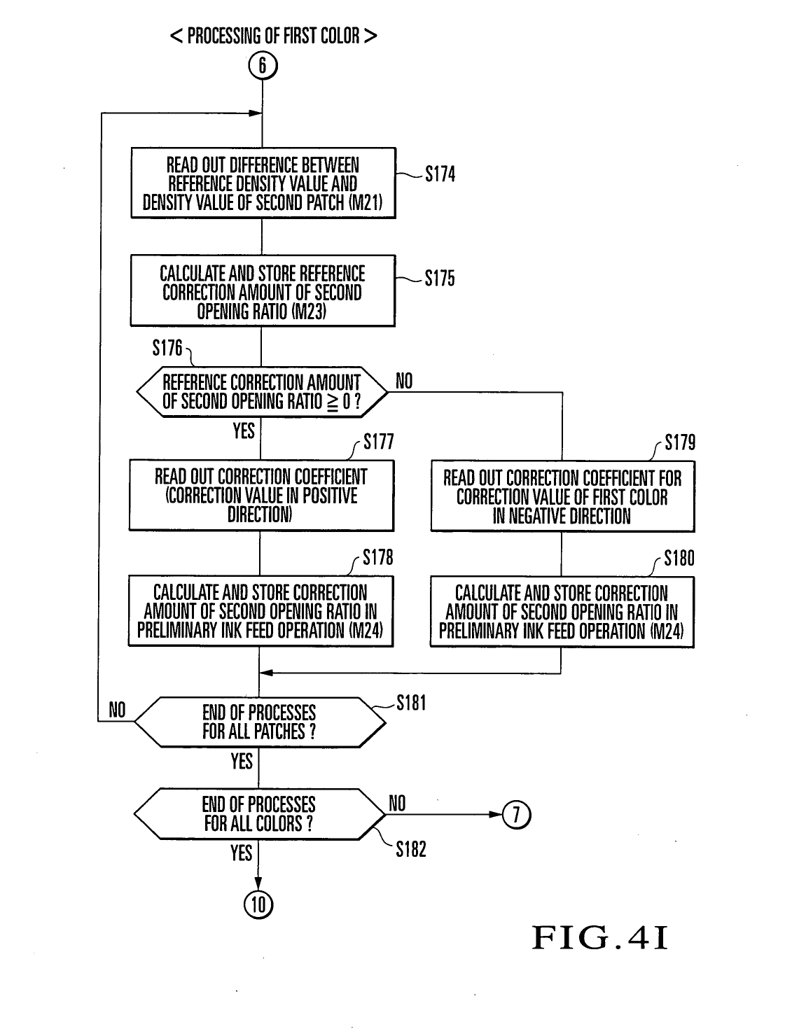

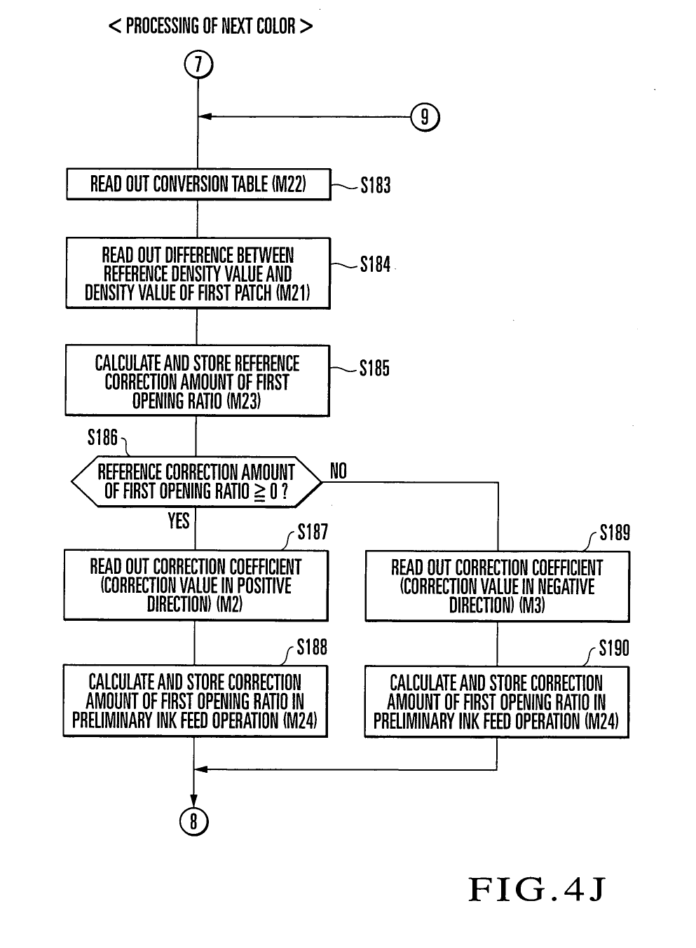

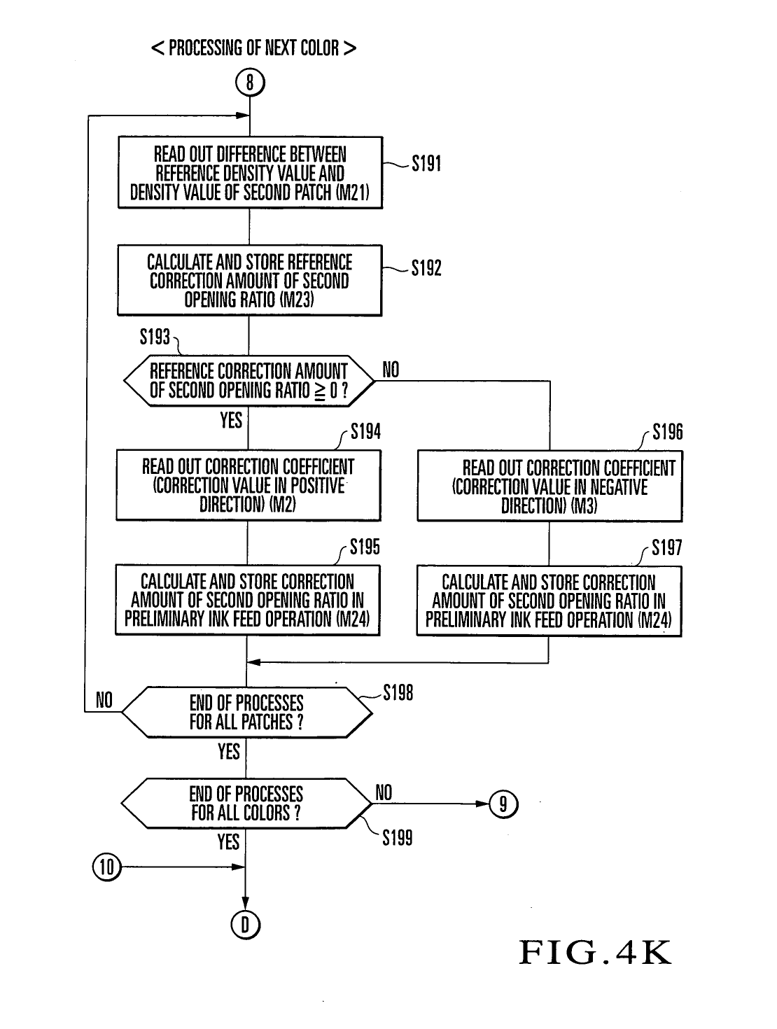

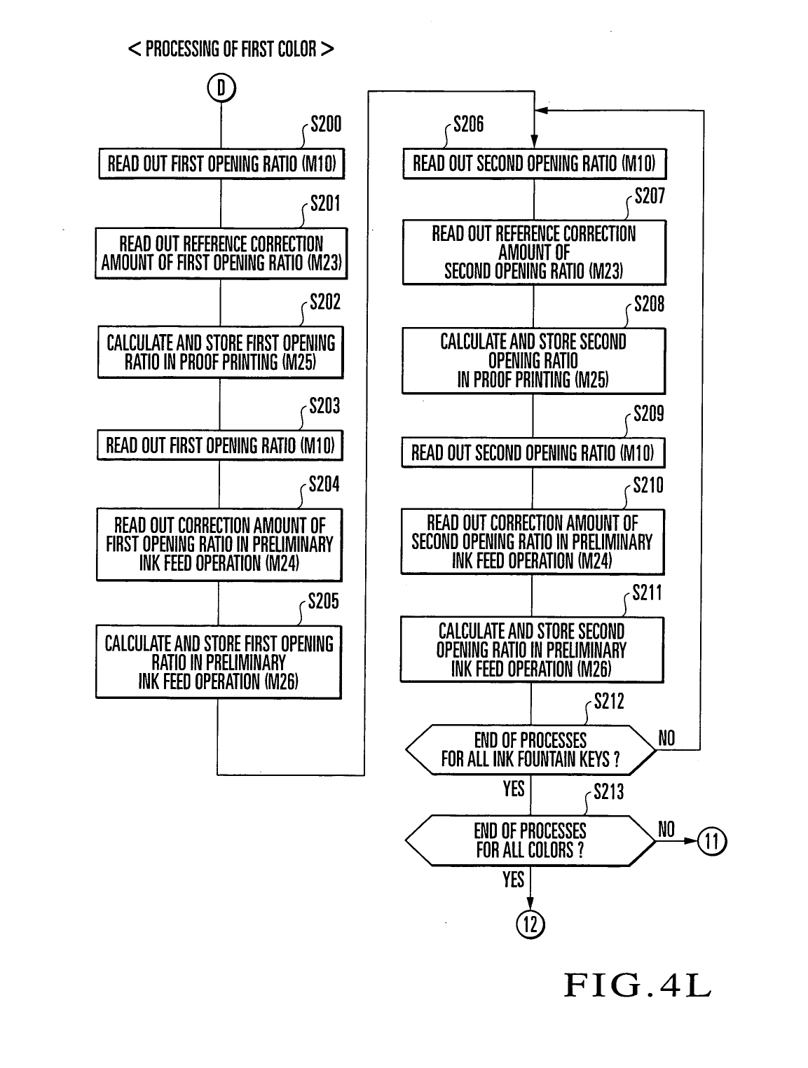

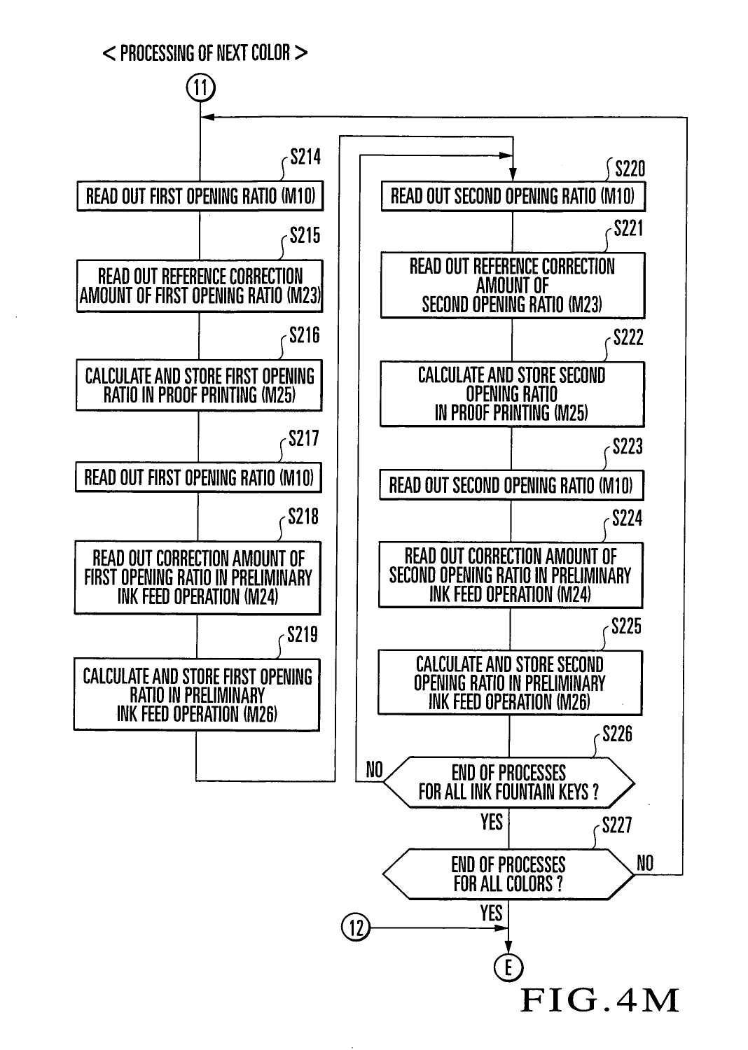

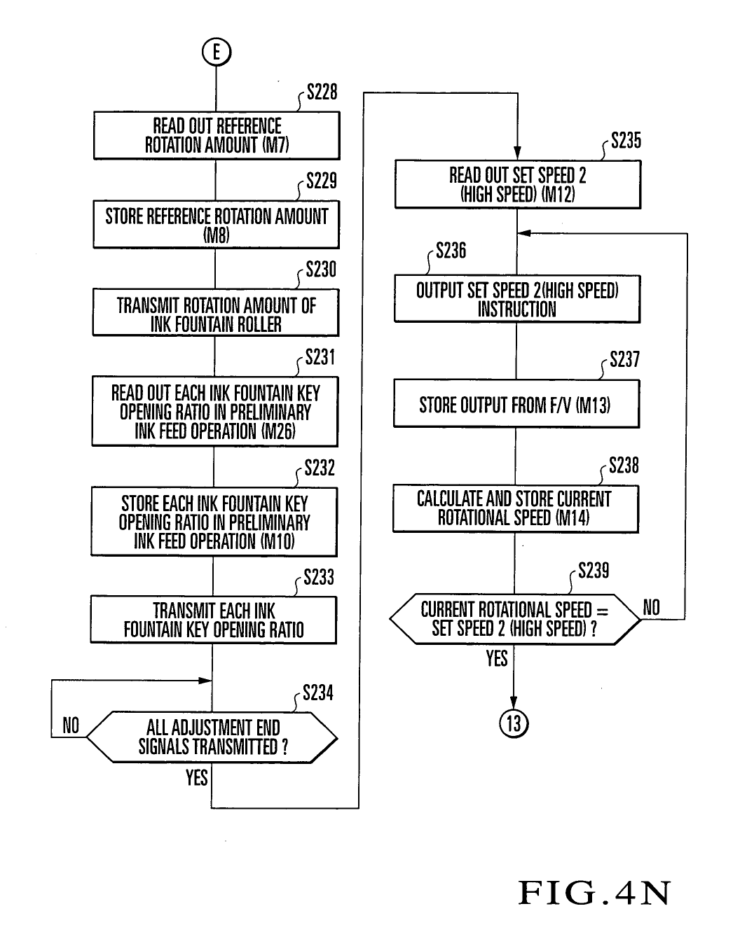

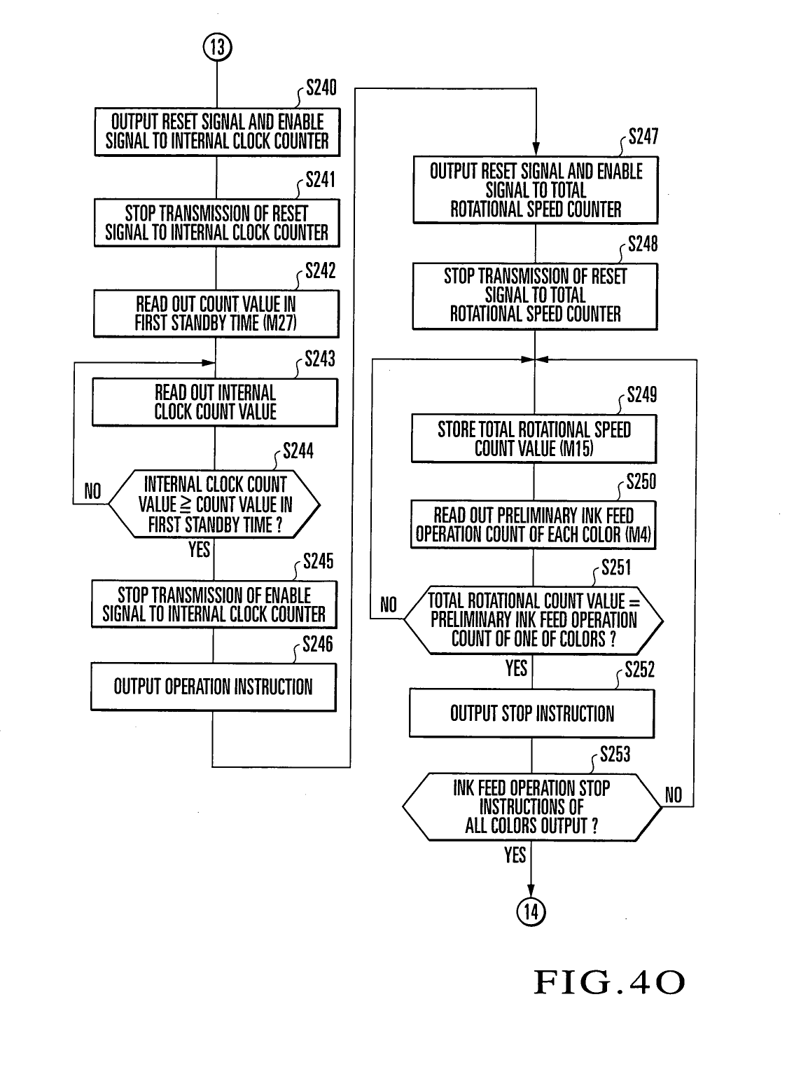

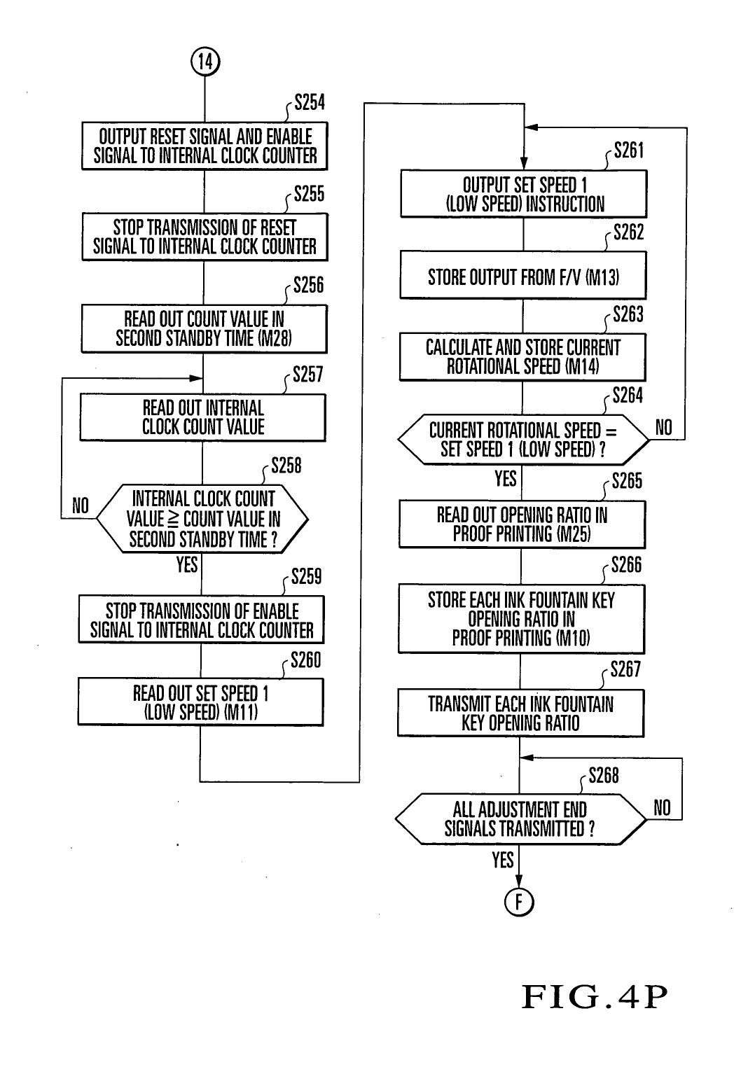

Prior to proof printing, an operator inputs, using the input device 10D, the number of paper sheets to be subjected to proof printing (FIG. 4A: step S101). The operator also inputs, using the input device 10D, the correction coefficient for the correction value of each color in the positive direction, the correction coefficient for the correction value of each color in the negative direction, the number of preliminary ink feed operations of each color, and the position of each patch of each color in the color bar serving as a proof printing sample (steps S103, S105, S107, and S109).

The CPU 10A causes the memory M1 to store the input number of paper sheets to be subjected to proof printing (step S102), causes the memory M2 to store the correction coefficient for the correction value of each color in the positive direction (step S104), causes the memory M3 to store the correction coefficient for the correction value of each color in the negative direction (step S106), and causes the memory M4 to store the number of preliminary ink feed operations of each color (step S108).

On the basis of the input position of each patch of each color in the color bar serving as a proof printing sample, the CPU 10A calculates the position of each patch of each color in the color bar serving as the proof printing sample which is to be measured by the colorimeter, i.e., the position (measurement position) of each patch of each color for measuring the density in the color bar. The memory M5 stores the obtained measurement position (steps S110 and S111).

The operator then inputs the image area ratio in a range corresponding to each ink fountain key of each color in proof printing, i.e., the image area ratio in each zone of each printing plate for the printing product to be subjected to proof printing corresponding to each ink fountain key of each color (step S112). In this example, a flexible disk on which the image area ratio of the region of each printing plate corresponding to the ink fountain key of each color is written is set in the output device 10F. The CPU 10A reads out the image area ratio in the region of each printing plate corresponding to the ink fountain key of each color from the flexible disk set in the output device 10F, and stores the readout image area ratio in the memory M6.

In this embodiment, to measure the image area ratio in each zone of the printing plate, an “image area ratio measuring device” disclosed in Japanese Patent Laid-Open Nos. 58-201008 and 58-201010 by the present applicant is used. The image area ratio measured by using the “image area ratio measuring device” is written in a flexible disk. The flexible disk in which the image area ratio is written is set in the output device 10F. The CPU 10A and the “image area ratio measuring device” may be connected online to directly receive the image area ratio in each zone of a new printing plate from the “image area ratio measuring device”.

[Proof Printing Preset]

The operator then turns on the proof printing preset switch SW1. When the proof printing preset switch SW1 is turned on (FIG. 4B: YES in step S114), the CPU 10A reads out the reference ink fountain roller rotation amount of each color from the memory M7 (step S115). The readout reference rotation amount is set, in the memory M8, as the ink fountain roller rotation amount of each color in proof printing (step S116). Additionally, the readout reference rotation amount is transmitted to the ink fountain roller control device 15 of each color (step S117). Accordingly, the rotation amount of the ink fountain roller 3 is set as the reference rotation amount in a printing unit 13 of each color.

The CPU 10A reads out, from the memory M6, the image area ratio of a range corresponding to each ink fountain key of each color in proof printing (step S118). The CPU 10A obtains, using the “image area ratio—ink fountain key opening ratio conversion table” of each color in the memory M9, the ink fountain key opening ratio of each color on the basis of the image area ratio in the range corresponding to the ink fountain key of each color in proof printing. The obtained ink fountain key opening ratio is set, in the memory M10, as the ink fountain key opening ratio (first time) of each color in proof printing (steps S119 and S120), and transmitted to an ink fountain key control device 16 of each color (step S121). Accordingly, in the printing unit 13 of each color, the opening ratios of the ink fountain keys 4-1 to 4-n are set to the opening ratios in proof printing.

Upon receiving, from all the ink fountain key control devices 16, adjustment end signals which represent that the ink fountain key opening ratios have been adjusted to the opening ratios in proof printing (FIG. 4C: YES in step S122), the CPU 10A reads out, from the memory M11, the set speed 1 of the printing press (step S123) to output it to the printing press driving motor driver 10S (step S124). The CPU 10A then reads out an output voltage from the F/V converter 10U (step S125). The CPU 10A calculates the current rotational speed of the printing press on the basis of the output voltage from the F/V converter 10U (step S126) to compare the calculated rotational speed with the set speed 1 which is read out from the memory M11 (step S127). The operations in steps S124 to S127 are repeated to set the rotational speed of the printing press to the set speed 1 (low speed).

[Start of Proof Printing]

The operator turns on the proof printing start switch SW2. When the proof printing start switch SW2 is turned on (FIG. 4B: YES in step S128), the CPU 10A reads out the set speed 2 of the printing press from the memory M12 (FIG. 4D: step S129) to set the rotational speed of the printing press to the set speed 2 (high speed) (steps S130 to S133).

The CPU 10A transmits an operation instruction to the ink feed device 14 of each color (step S134), transmits a print start instruction to the printing unit 13 of each color (step S135), and transmits a sheet feeding start instruction to the sheet feeding device 10Y (step S136). The CPU 10A then transmits a reset signal and enable signal to the counter 10X for counting the total rotational speed of the printing press (step S137) to start the count operation of the counter 10×(step S138). As a result, the count value of the counter 10X is set to 0 to start proof printing.

The CPU 10A then reads out, from the memory M1, the number of paper sheets to be subjected to proof printing (step S139). When the count value (number of paper sheets to be printed) of the counter 10X equals the number of paper sheets to be subjected to proof printing which is read from the memory M1 (YES in step S141), the CPU 10A transmits a sheet feeding stop instruction to the sheet feeding device 10Y (FIG. 4E: step S142), transmits a print stop instruction to the printing unit 13 of each color (step S143), and transmits a stop instruction to the ink feed device 14 of each color (step S144). After that, the rotational speed of the printing press is set to the set speed 1 (low speed) (steps S145 to S149) to end proof printing.

[Re-preset of Proof Printing]

The operator extracts one of the printed products (printed by proof printing), and sets it as a proof printing sample 9′ on the measurement table 17-4 (FIG. 3). In this state, a color bar 9-2 printed on the proof printing sample 9′ is located under a head portion 10H1 of the colorimeter 10H.

[Color Data Sampling]

In this state, the operator turns on the proof printing re-preset switch SW3. When the proof printing re-preset switch SW3 is turned on (FIG. 4B: YES in step S150), the CPU 10A rotates the calorimeter moving motor 10I in the forward direction (FIG. 4F: step S151). The ball screw 17-3 is rotated in the forward direction by rotating the calorimeter moving motor 10I in the forward direction. The colorimeter 10H is guided by the ball screw 17-3 to move from the home position in contact with the column 17-1 toward the column 17-2.

The CPU 10A loads the count value of the counter 10L for measuring the current position of the colorimeter (step S152), and calculates the current position of the calorimeter 10H on the basis of the loaded count value (step S153). When the current position reaches the first measurement position stored in the memory M5 (YES in step S155), the color data of the patch 9a located at the measurement position is sampled by the colorimeter 10H, and the sampled color data is stored in the memory M18 (steps S156 and S157).

In a similar way, every time reaching the measurement position stored in the memory M5, the CPU 10A causes the colorimeter 10H to sample the color data of the patch 9a located at that measurement position, and stores the sampled color data in the memory M18. That is, the CPU 10A executes automatic scanning control of the colorimeter 10H to sequentially sample the color data of the density measurement color patch 9a in the color bar 9-2 printed on the proof printing sample 9′.

When the CPU 10A determines whether the color data sampling of all patches 9a in the color bar 9-2 printed on the proof printing sample 9′ is ended (step S158), the forward rotation of the colorimeter moving motor 10I is stopped (FIG. 4G: step S159). Next, the CPU 10A rotates the colorimeter moving motor 10I in the reverse direction (step S160). When the colorimeter 10H returns to the home position (YES in step S161), the reverse rotation of the calorimeter moving motor 10I is stopped (step S162).

[Calculation of Density Difference]

The CPU 10A calculates the density value of the patch 9a of each color from the color data of the patch 9a of each color stored in the memory M18, and stores the density value as the measured density value in the memory M19 (step S163). In this embodiment, a spectrometer is used as the colorimeter 10H. The output value of each wavelength from the spectrometer is multiplied by the transmittance of each wavelength of the filter to be used to measure the solid patch of each color by a densitometer. The calculated values are totalized to obtain the density value of each color.

The CPU 10A reads out the reference density value of each color from the memory M20 (step S164). The measured density value of the patch 9a of each color stored in the memory M19 is subtracted from the reference density value of each color. The obtained value is stored, in the memory M21, as the measured density difference of the patch 9a of each color on the proof printing sample 9′ (step S165).

[Calculation of Reference Correction Amount of Ink Fountain Key Opening Ratio, and Correction Amount in Preliminary Ink Feed Operation]

The CPU 10A reads out, from the memory M22, the “density difference—ink fountain key opening ratio correction amount conversion table” of the first color (FIG. 4H: step S166). The CPU 10A reads out, from the memory M21, the measured density difference of the first patch of the first color on the proof printing sample 9′ (step S167). The CPU 10A obtains, using the “density difference—correction amount of ink fountain key opening ratio conversion table” of the first color, the reference correction amount of the first ink fountain key opening ratio of the first color on the basis of the measured density difference of the first patch of the first color on the proof printing sample 9′. The obtained reference correction amount is stored in the memory M23 (step S168).

The CPU 10A checks whether the reference correction amount of the first ink fountain key opening ratio of the first color has a positive/negative value (step S169). If the reference correction amount has a positive value (≧0), the CPU 10A reads out, from the memory M2, the correction coefficient (>1) for the correction value of the first color in the positive direction (step S170). The reference correction amount of the first ink fountain key opening ratio of the first color is multiplied by the readout correction coefficient. The obtained value is stored, in the memory M24, as the correction amount of the first ink fountain key opening ratio of the first color in the preliminary ink feed operation (step S171).

In step S169, if the reference correction amount of the first ink fountain key opening ratio of the first color has a negative value (<0), the CPU 10A reads out, from the memory M3, the correction coefficient (>1) for the correction value of the first color in the negative direction (step S172). The reference correction amount of the first ink fountain key opening ratio of the first color is multiplied by the readout correction coefficient. The obtained value is stored, in the memory M24, as the correction amount of the first ink fountain key opening ratio of the first color in the preliminary ink feed operation (step S173).

The CPU 10A reads out, from the memory M21, the measured density difference of the second patch of the first color on the proof printing sample 9′ (FIG. 4I: step S174). The CPU 10A obtains, using the “density difference—correction amount of ink fountain key opening ratio conversion table” of the first color, the reference correction amount of the second ink fountain key opening ratio of the first color on the basis of the measured density difference of the second patch of the first color on the proof printing sample 9′. The obtained reference correction amount is stored in the memory M23 (step S175).

The CPU 10A checks whether the reference correction amount of the second ink fountain key opening ratio of the first color has a positive/negative value (step S176). If the reference correction amount has a positive value (>0), the CPU 10A reads out, from the memory M2, the correction coefficient (>1) for the correction value of the first color in the positive direction (step S177). The reference correction amount of the second ink fountain key opening ratio of the first color is multiplied by the readout correction coefficient. The obtained value is stored, in the memory M24, as the correction amount of the second ink fountain key opening ratio of the first color in the preliminary ink feed operation (step S178).

In step S176, if the reference correction amount of the second ink fountain key opening ratio of the first color has a negative value (<0), the CPU 10A reads out, from the memory M3, the correction coefficient (>1) for the correction value of the first color in the negative direction (step S179). The reference correction amount of the second ink fountain key opening ratio of the first color is multiplied by the readout second coefficient. The obtained value is stored, in the memory M24, as the correction amount of the second ink fountain key opening ratio of the first color in the preliminary ink feed operation (step S180).

The CPU 10A repeats the operations in steps S174 to S181 for the measured density differences of all patches of the first color on the proof printing sample 9′ in the memory M21. If the operations are not ended for all colors, similar to the processes (steps S166 to S182) for the first color, the CPU 10A obtains the reference correction amounts of the ink fountain key opening ratios for the respective measured density differences of all patches of all colors on the proof printing sample 9′ in the memory M21. The CPU 10A determines whether the reference correction amount has a positive/negative value. The obtained reference correction amount is multiplied by the correction coefficient in the positive/negative direction, and the obtained value is stored, in the memory M24, as the correction amount of the ink fountain key in the preliminary ink feed operation (FIGS. 4J and 4K: steps S183 to S199).

[Calculation of Ink Fountain Key Opening Ratio in Preliminary Ink Feed Operation, and Ink Fountain Key Opening Ratio in Proof Printing]

The CPU 10A reads out, from the memory M10, the first ink fountain key opening ratio (current opening ratio) of the first color (FIG. 4L: step S200), and then reads out, from the memory M23, the reference correction amount of the first ink fountain key opening amount of the first color (step S201). The reference correction amount of the first ink fountain key opening ratio of the first color is added to the first ink fountain key opening ratio (current opening ratio) of the first color. The obtained value is stored, in the memory M25, as the first ink fountain key opening ratio of the first color in proof printing (step S202).

The CPU 10A also reads out, from the memory M10, the first ink fountain key opening ratio (current opening ratio) of the first color (step S203), and reads out, from the memory M24, the correction amount of the first ink fountain key opening ratio of the first color in the preliminary ink feed operation (step S204). The correction amount of the first ink fountain key opening ratio of the first color in the preliminary ink feed operation is added to the first ink fountain key opening ratio (current opening ratio) of the first color, and the obtained value is stored, in the memory 26, as the first ink fountain key opening ratio of the first color in the preliminary ink feed operation (step S205).

The CPU 10A reads out, from the memory M10, the second ink fountain key opening ratio (current opening ratio) of the first color (step S206), and reads out, from the memory M23, the reference correction amount of the second ink fountain key opening ratio of the first color (step S207). The reference correction amount of the second ink fountain key opening ratio of the first color is added to the second ink fountain key opening ratio (current opening ratio) of the first color. The obtained value is stored, in the memory M25, as the second ink fountain key opening ratio of the first color in proof printing (step S208).

The CPU 10A reads out, from the memory M10, the second ink fountain key opening ratio (current opening ratio) of the first color (step S209), and reads out, from the memory M24, the correction amount of the second ink fountain key opening ratio of the first color in the preliminary ink feed operation (step S210). The correction amount of the second ink fountain key opening ratio of the first color in the preliminary ink feed operation is added to the second ink fountain key opening ratio (current opening ratio) of the first color. The obtained value is stored, in the memory M26, as the second ink fountain key opening ratio of the first color in the preliminary ink feed operation (step S211).

The CPU 10A repeats the operations in steps S206 to S212 for all ink fountain key opening ratios (current opening ratios) of the first color in the memory M10. If the operations are not ended for all colors, similar to the processes for the first color (steps S200 to S213), the CPU 10A obtains the ink fountain key opening ratio in proof printing for the respective ink fountain key opening ratios (current opening ratios) of all colors in the memory M10. The obtained value is stored in the memory M25. After that, the ink fountain key opening ratio in the preliminary ink feed operation is obtained and stored in the memory M26 (FIG. 4M: steps S214 to S227).

[Adjustment to Opening Ratio in Preliminary Ink Feed Operation]

When the operations are ended for all colors (YES in step S227), the CPU 10A reads out, from the memory M7, the reference rotation amount of the ink fountain roller of each color, and the readout reference rotation amount is transmitted to the ink fountain roller control device 15 of each color. Accordingly, the rotation amount of the ink fountain roller 3 in the printing unit 13 of each color serves as the reference rotation amount (FIG. 4N: steps S228 to S230).

The CPU 10A reads out, from the memory M26, the ink fountain key opening ratio of each color in the preliminary ink feed operation. The CPU 10A sets the obtained ink fountain key opening ratio of each color in the preliminary ink feed operation to the memory M10 and transmits the ink fountain key opening ratio to the ink fountain key control device 16 of each color. The CPU 10A then adjusts the opening ratios of the ink fountain keys 4-1 to 4-n in the printing unit of each color, into the opening ratios in the preliminary ink feed operation (steps S231 to S233).

Upon receiving, from all the ink fountain key control devices 16, the adjustment end signals which represent that the ink fountain key opening ratios are adjusted into the opening ratios in the preliminary ink feed operation (YES in step S234), the CPU 10A reads out the set speed 2 of the printing press from the memory M12 (step S235), and sets the rotational speed of the printing press to the set speed 2 (high speed) (steps S236 to S239).

The CPU 10A transmits the reset signal and enable signal to the internal clock counter 10Q (FIG. 40: step S240) to start the count operation of the internal clock counter 10Q (step S241). After that, the CPU 10A reads out the count value in the first standby time from the memory M27 (step S242), and waits until the count value of the internal clock counter 10Q reaches the count value in the first standby time (steps S243 and S244). For the first standby time, the printing press is kept idle at the set speed 2 (high speed).

[Preliminary Ink Feed Operation]

After the first standby time has elapsed, the CPU 10A stops transmitting the enable signal to the internal clock counter 10Q (step S245), and transmits the operation instruction to the ink feed device 14 of each color (step S246). The CPU 10A transmits the reset signal and enable signal to the counter 10X for counting the total rotational speed of the printing press (step S247), and starts the count operation of the counter 10X (step S248). Accordingly, the count value of the counter 10X is set to 0, and the ink feed operation of an ink ductor roller 5 is started in the printing unit 13 of each color. That is, in the printing unit 13 of each color, the ink feed operation (preliminary ink feed operation) of the ink ductor roller 5 is started in the state wherein the opening ratios of ink fountain keys 4-1 to 4-n are set to the opening ratios in the preliminary ink feed operation without printing.

In the ink feed operation of the ink ductor roller 5 of each color, the CPU 10A reads out, from the memory M4, the number of preliminary ink feed operations of the respective colors, and compares the readout value with the count value of the counter 10X (steps S249 to S251). When the count value of the counter 10X equals the number of preliminary ink feed operations of one of colors (YES in step S251), the CPU 10A transmits a stop instruction to the ink feed device 14 of the corresponding color (step S252). In a similar way, the operations in steps S249 to S253 are repeated until the count value of the counter 10X equals the number of preliminary ink feed operations of all colors.

Accordingly, in the printing unit 13 of each color, the opening ratio of the ink fountain key 4 increases in an area in which the measured density value is smaller than the reference density value, and an amount of ink corresponding to the shortage is supplied to ink rollers 6. On the other hand, the opening ratio of the ink fountain key 4 decreases in an area in which the measured density value is larger than the reference density value, and the excessive ink is returned from the ink rollers 6 to an ink fountain 1.

That is, in the area in which the measured density value is smaller than the reference density value, ink is added to the residual ink on the ink rollers 6. On the other hand, in the area in which the measured density value is larger than the reference density value, the residual ink on the ink rollers 6 is partially returned to the ink fountain 1 to decrease the amount of ink on the ink rollers 6.

If the preliminary ink feed operations are ended in the printing units 13 of all colors (YES in step S253), the CPU 10A outputs stop instructions to all the ink feed devices 14 (YES in step S253). After that, the CPU 10A transmits the reset signal and enable signal to the internal clock counter 10Q (FIG. 4P: step S254) to start the count operation of the internal clock counter 10Q (step S255). The CPU 10A then reads out the count value in the second standby time from the memory M28 (step S256), and the printing press is kept idle for the second standby time (steps S257 and S258).

[Adjustment to Opening Ratio in Proof Printing]

After the second standby time has elapsed (YES in step S258), the CPU 10A stops transmitting the enable signal to the internal clock counter 10Q (step S259), and the rotational speed of the printing press is set to the set speed 1 (low speed) (steps S260 to S264).

The CPU 10A reads out, from the memory M25, the ink fountain key opening ratio of each color in proof printing (step S265). The CPU 10A sets, in the memory M10, the readout ink fountain key opening ratio as the ink fountain key opening ratio of each color in second proof printing (step S266), and transmits the ink fountain key opening ratio to the ink fountain key control device 16 of each color (step S267). As a result, in the printing unit 13 of each color, the opening ratios of the ink fountain keys 4-1 to 4-n are set to the opening ratios in second proof printing.

[Start of Proof Printing (Second Time)]

The operator then turns on the proof printing start switch SW2 again. When the proof printing start switch SW2 is turned on (FIG. 4B: YES in step S128), the CPU 10A sets the rotational speed of the printing press to the set speed 2 (high speed) (FIG. 4D: steps S129 to S133), and executes second proof printing (steps S134 to S144). After that, the CPU 10A sets the rotational speed of the printing press to the set speed 1 (low speed) (steps S145 to S149).

In a Similar way, “re-preset of proof printing” and “start of proof printing” are repeated until satisfactory proof printing is performed. In order to perform proof printing again in this embodiment, an amount of ink corresponding to the shortage is supplied to the ink rollers 6 in the area wherein the measured density value is smaller than the reference density value, and the excessive ink is returned from the ink rollers 6 to the ink fountain 1 in the area wherein the measured density value is larger than the reference density value, by “re-preset of proof printing” in the printing unit 13 of each color. Hence, the response speed of a print density can be increased in restarting proof printing. As a result, the ink supply amount can be adjusted within a short time, and the amount of wasted paper can decrease.

Especially, in the first embodiment, the reference correction amount of the ink fountain key opening ratio is multiplied by the predetermined correction coefficient (>1) to obtain the correction amount, and the obtained correction amount is added to the current ink fountain key opening ratio to obtain the ink fountain key opening ratio in the preliminary ink feed operation. That is, the ink fountain key opening ratio increases when the reference correction amount has a positive value, and the ink fountain key opening ratio decreases when the reference correction amount has a negative value, resulting in an advantage to execute normal proof printing at high speed.

Note that the reference correction amount need not always be multiplied by a predetermined correction coefficient. For example, a predetermined value may be added to the reference correction amount to obtain a correction amount which has a large absolute value with the same sign. The obtained correction amount may be added to the current ink fountain key opening ratio to obtain the ink fountain key opening ratio in the preliminary ink feed operation.

[Ink Fountain Roller Control Device]

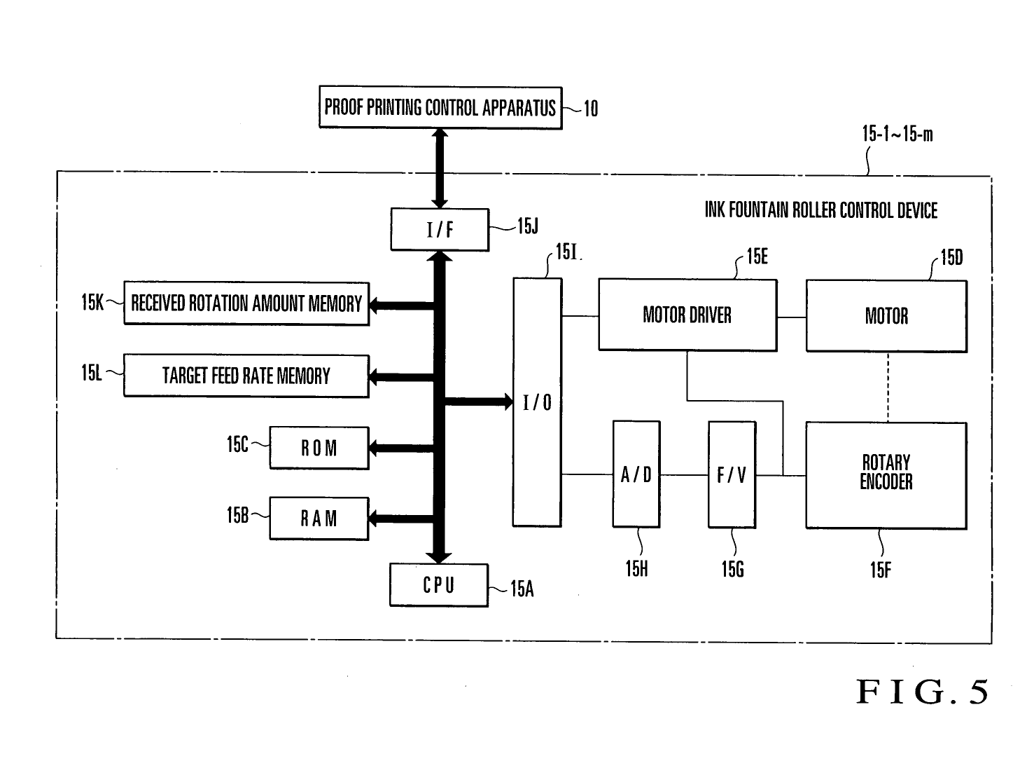

FIG. 5 schematically shows an internal arrangement of each of the ink fountain roller control devices 15-1 to 15-m. An ink fountain roller control device 15 comprises a CPU 15A, a RAM 15B, a ROM 15C, an ink fountain roller driving motor 15D, an ink fountain roller driving motor driver 15E, a rotary encoder 15F for the ink fountain roller driving motor, an F/V converter 15G, an A/D converter 15H, input/output interfaces (I/Os, I/Fs) 15I and 15J, and memories 15K and 15L. The ink fountain roller control device 15 is connected to the proof printing control device 10 through the interface 15J. The memory 15K stores the received rotation amount of the ink fountain roller. The memory 15L stores a target feed rate of the ink fountain roller.

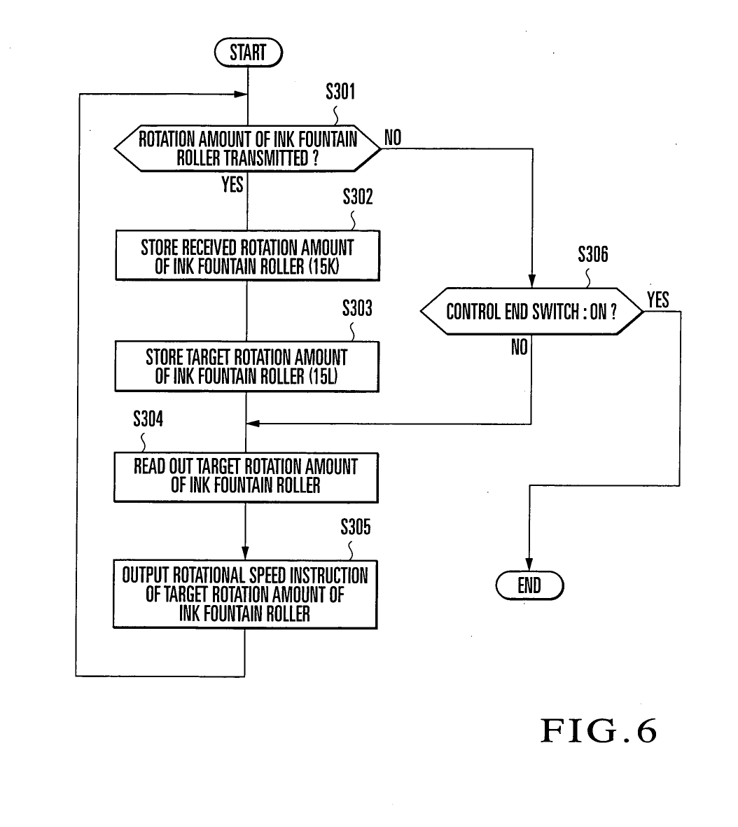

Upon receiving the ink fountain roller rotation amount from the proof printing control device 10 (FIG. 6: YES in step S301), the CPU 15A causes the memory 15K to store the received rotation amount (step S302). The memory 15L stores the received ink fountain roller rotation amount as a target ink fountain roller feed rate (target rotation amount). The CPU 15A reads out the target rotation amount from the memory 15L (step S304), and transmits the readout target rotation amount to the ink fountain roller driving motor driver 15E to set the rotation amount of the ink fountain roller driving motor 15D to the target rotation amount (step S305).

[Ink Fountain Key Control Device]

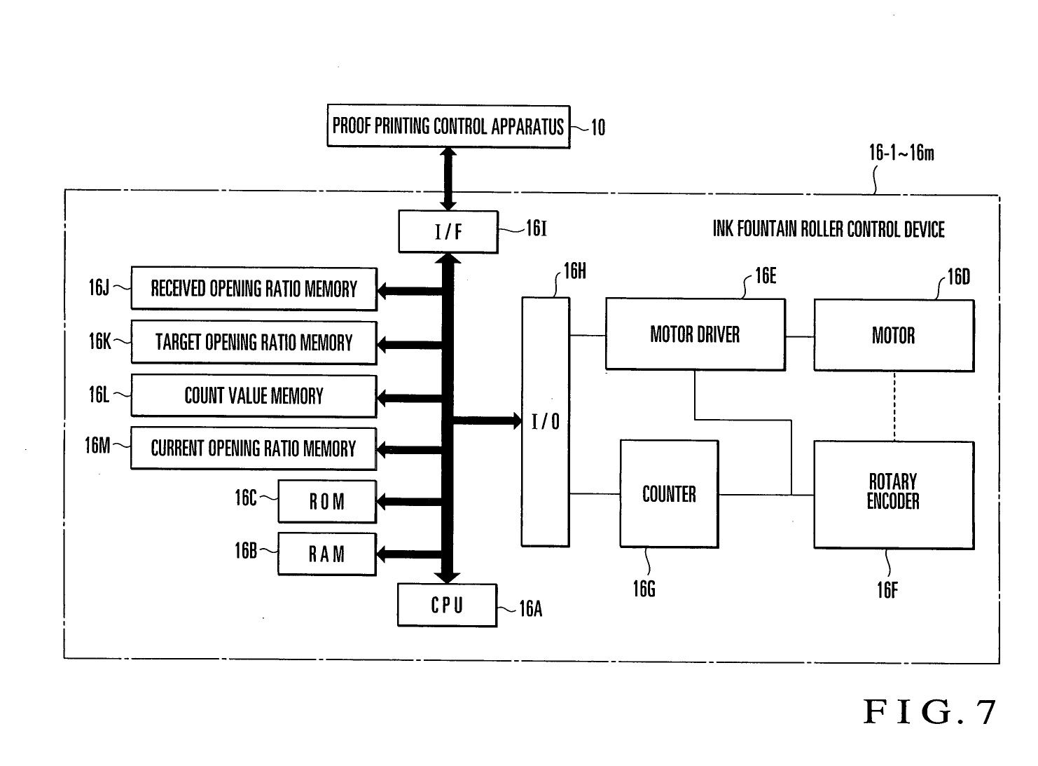

FIG. 7 schematically shows the internal arrangement of each of the ink fountain key control devices 16-1 to 16-n. The ink fountain key control device 16 comprises a CPU 16A, a RAM 16B, a ROM 16C, an ink fountain key driving motor 16D, an ink fountain key driving motor driver 16E, a rotary encoder 16F for the ink fountain key driving motor, a counter 16G, input/output interfaces (I/Os, I/Fs) 16H and 16I, and memories 16J to 16M. The ink fountain key control device 16 is connected to the proof printing control device 10 through the interface 16I. The memory 16J stores the received ink fountain key opening ratio. The memory 16K stores the target ink fountain key opening ratio. The memory 16L stores the count value of the counter 16G. The memory 16M stores the current ink fountain key opening ratio.

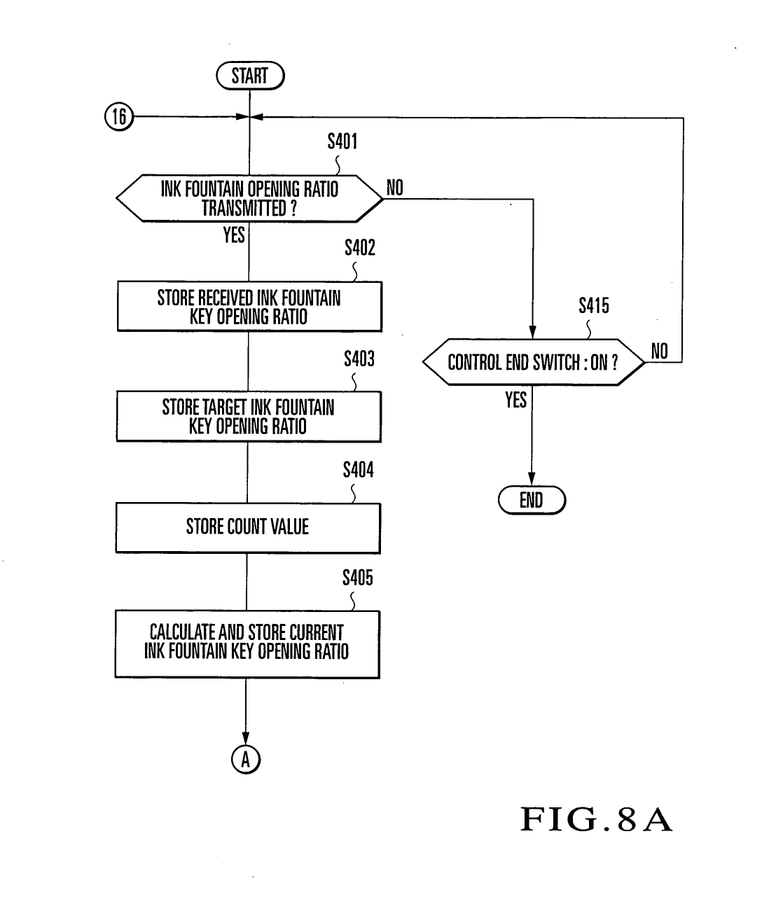

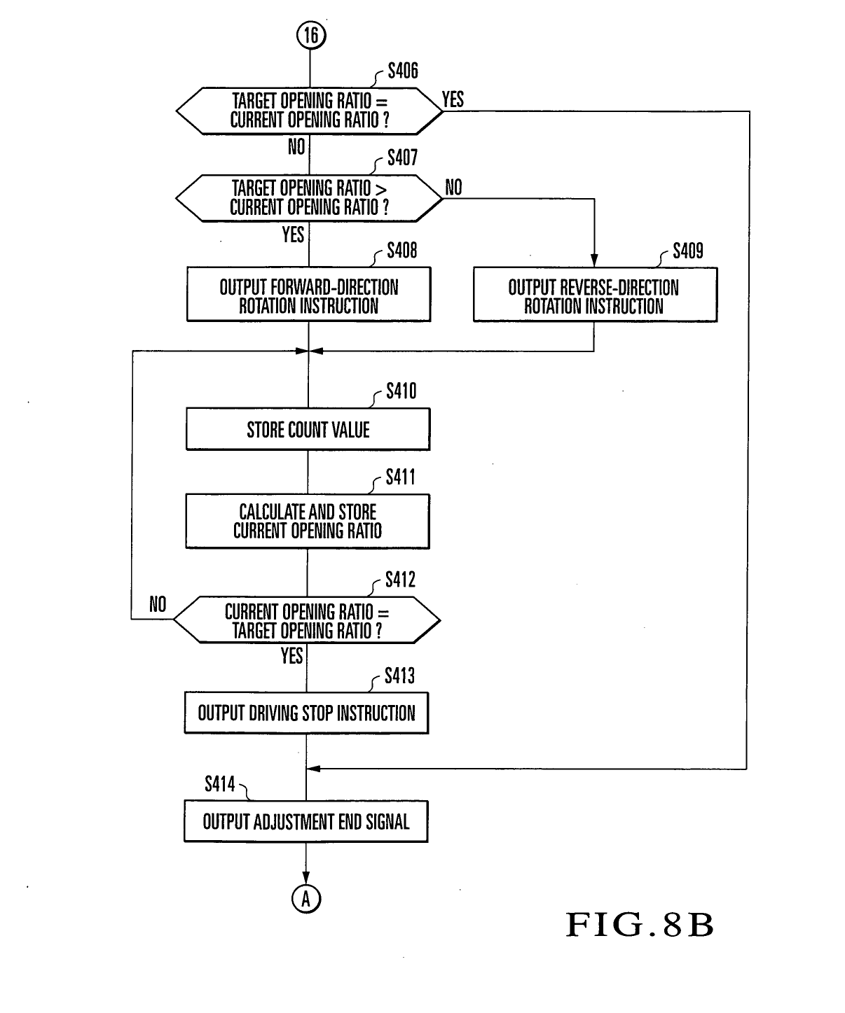

Upon receiving the ink fountain key opening ratio from the proof printing control device 10 (FIG. 8A: YES in step S401), the CPU 16A causes the memory 16J to store the received opening ratio (step S402), and causes the memory 16K to store the received opening ratio as the target opening ratio (step S403). The CPU 16A reads out the count value of the counter 16G (step S404) to obtain the current ink fountain key opening ratio on the basis of the readout count value of the counter 16G (step S405). If the current ink fountain key opening ratio equals the target opening ratio (FIG. 8B: YES in step S406), the flow immediately advances to step S414 to output an ink fountain key opening ratio adjustment end signal to the proof printing control device 10.

If the current ink fountain key opening ratio does not equal the target opening ratio (NO in step S406), the ink fountain key driving motor 16D is driven until the current ink fountain key opening ratio equals the target opening ratio (adjusted opening ratio) (steps S407 to S413). After that, the ink fountain key opening ratio adjustment end signal is output to the proof printing control device 10 (step S414).

According to this embodiment, the density value of a printed paper sheet (printing product) is measured, and the ink fountain key opening ratio is corrected on the basis of the difference between the density value (measured density value) of the printing product, and the reference density value. Conventionally, printing is restarted immediately after correction of the ink fountain key opening ratio. However, in the present invention, an ink feed operation of the ink ductor roller is executed in a state wherein the ink fountain key opening ratio is corrected without printing. In this case, when the measured density value is smaller than the reference density value, the ink fountain key opening ratio increases upon supplying an amount of ink corresponding to the shortage to the ink transfer path to increase the response speed of the print density in restarting printing. On the other hand, when the measured density value is larger than the reference density value, the ink fountain key opening ratio decreases upon returning the excessive ink from the ink transfer path to the ink fountain to decrease the response speed of the print density in restarting printing.

### Second Embodiment

In the first embodiment, the reference correction amount of the ink fountain key opening ratio is multiplied by a predetermined correction coefficient (>1) to obtain the correction amount. This correction amount is added to the current ink fountain key opening ratio to obtain the ink fountain key opening ratio in the preliminary ink feed operation. In contrast to this, in the second embodiment, the reference correction amount of the ink fountain key opening ratio is added to the current ink fountain key opening ratio to obtain the ink fountain key opening ratio in the preliminary ink feed operation. In this case, the ink fountain key opening ratio of each color in the preliminary ink feed operation equals the ink fountain key opening ratio of each color in next proof printing. Hence, the ink fountain key opening ratio need not be adjusted after the preliminary ink feed operation.

[Schematic Operation in Second Embodiment]

(1) Each data is input.

(2) A proof printing preset switch SW1 is turned on. Each ink fountain key opening ratio is obtained from the input image area ratio to set the obtained ink fountain key opening ratio. Additionally, each ink fountain roller feed rate is set as a reference value.

(3) The rotational speed of the printing press is set to a set speed 1 (low speed).

(4) A proof printing start switch SW2 is turned on. The rotational speed of the printing press is set to the set speed 2 (high speed) to perform proof printing on the set number of printing paper sheets. After that, the rotational speed of the printing press is set to the set speed 1 (low speed).

(5) A proof printing re-preset switch SW3 is turned on. The density of each color patch subjected to proof printing is measured to obtain the difference between the measured density of each color patch and the reference density.

(6) The reference correction amount of the ink fountain key opening ratio is obtained from the obtained density difference.

(7) The reference correction amount is added to the current ink fountain key opening ratio to obtain the ink fountain key opening ratio in a preliminary ink feed operation and proof printing.

(8) The ink fountain roller feed rate is set as a reference value, and the ink fountain key opening ratio is set to the opening ratio in the preliminary ink feed operation and proof printing which is obtained in (7). The rotational speed of the printing press is set to the set speed 2 (high speed), and the printing press is kept idle for the set first standby time.

(9) The ink feed device operates (the preliminary ink feed operation is performed) a predetermined number of times to supply ink to the inking device of the printing press. After that, the printing press is kept idle for the set second standby time.

(10) The rotational speed of the printing press is set to the set speed 1 (low speed).

(11) The proof printing start switch SW2 is turned on again. The rotational speed of the printing press is set to the set speed 2 (high speed) to perform proof printing on a set number of paper sheets. After that, the rotational speed of the printing press is set to the set speed 1 (low speed).

(12) The operations (5) to (11) are repeated until satisfactory proof printing is performed.

In the second embodiment, the arrangements of a proof printing control device, ink fountain roller control device, and ink fountain key control device are the same as those in FIGS. 1, 5, and 7 in the first embodiment, and a description thereof will be omitted. Note that the CPU 10A and memory 10G shown in FIG. 1 will be described as a CPU 10A′ and memory 10G′ in the second embodiment for the sake of convenience.

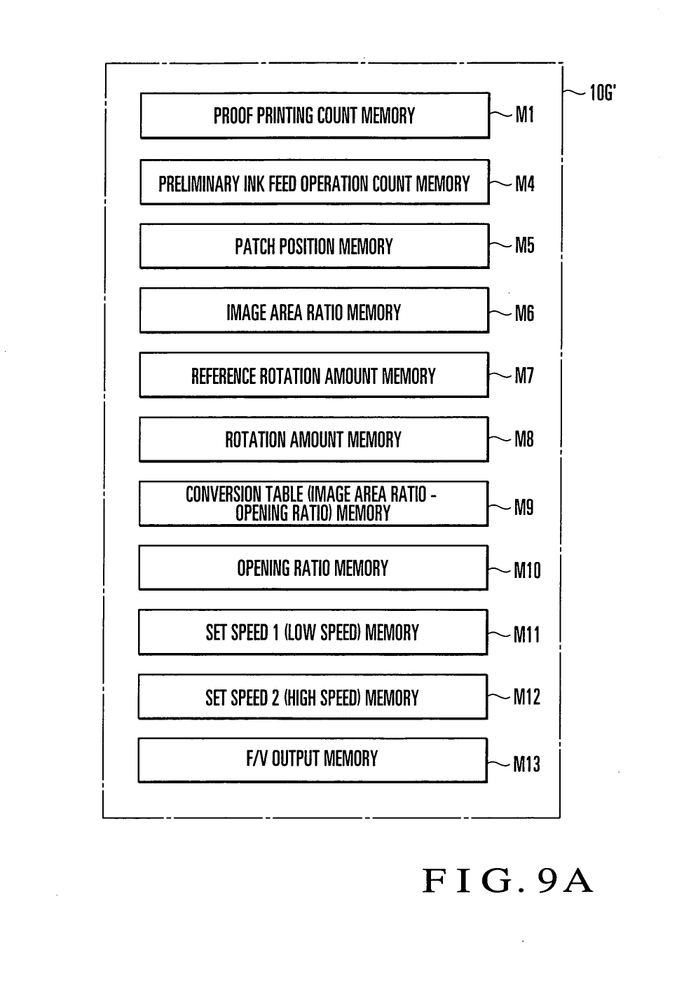

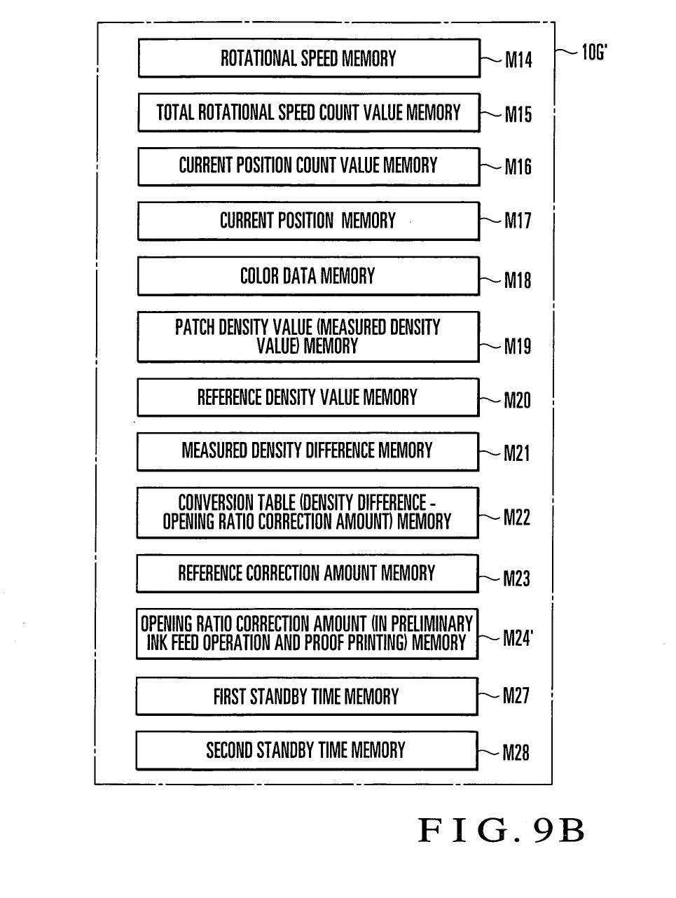

Referring to FIGS. 9A and 9B, in a memory 10′ according to the second embodiment, a memory M2 for storing a correction coefficient for a correction value of each color in the positive direction, a memory M3 for storing a correction coefficient for a correction value of each color in the negative direction, a memory M25 for storing an ink fountain key opening ratio of each color in proof printing, and a memory M26 for storing an ink fountain key opening ratio of each color in the preliminary ink feed operation will be omitted. A memory M24′ for storing the ink fountain key opening ratio of each color in the preliminary ink feed operation and proof printing is used in place of the memory M24.

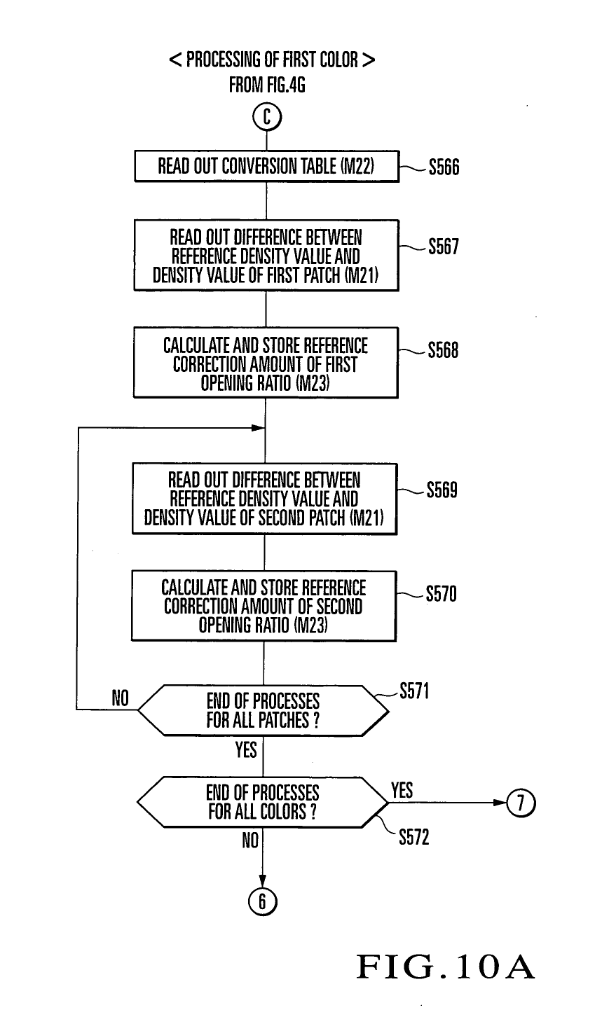

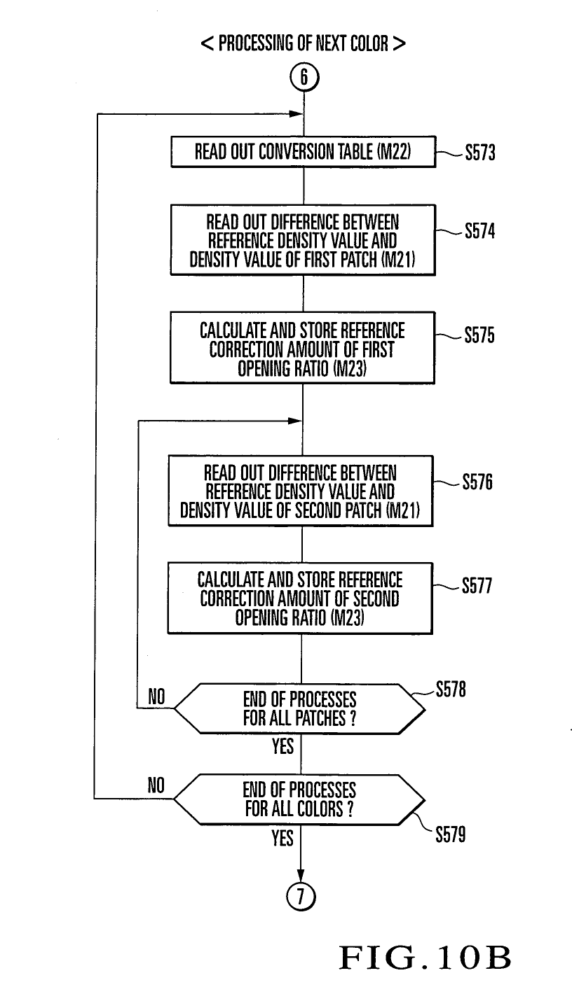

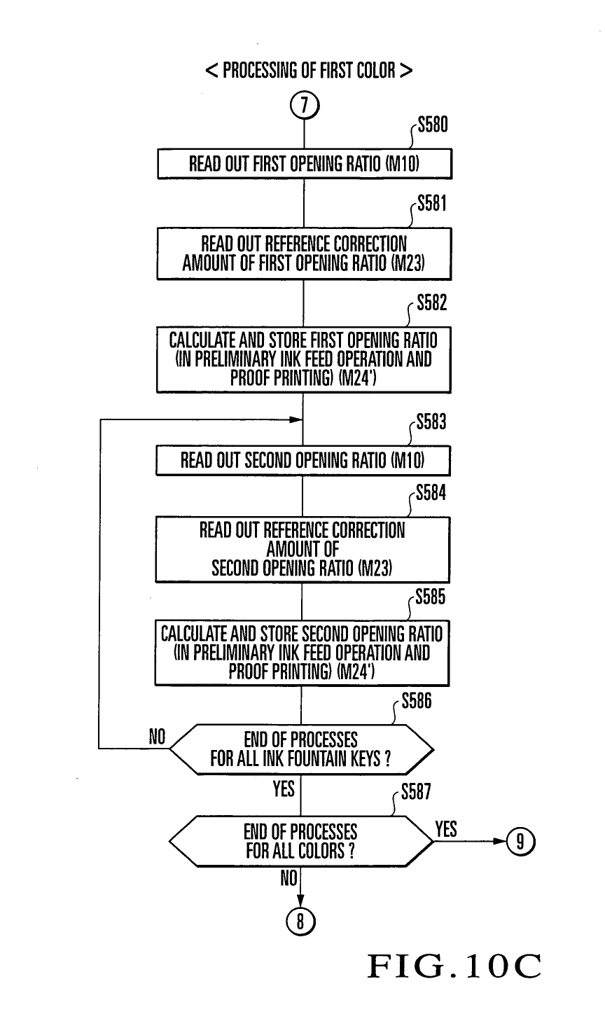

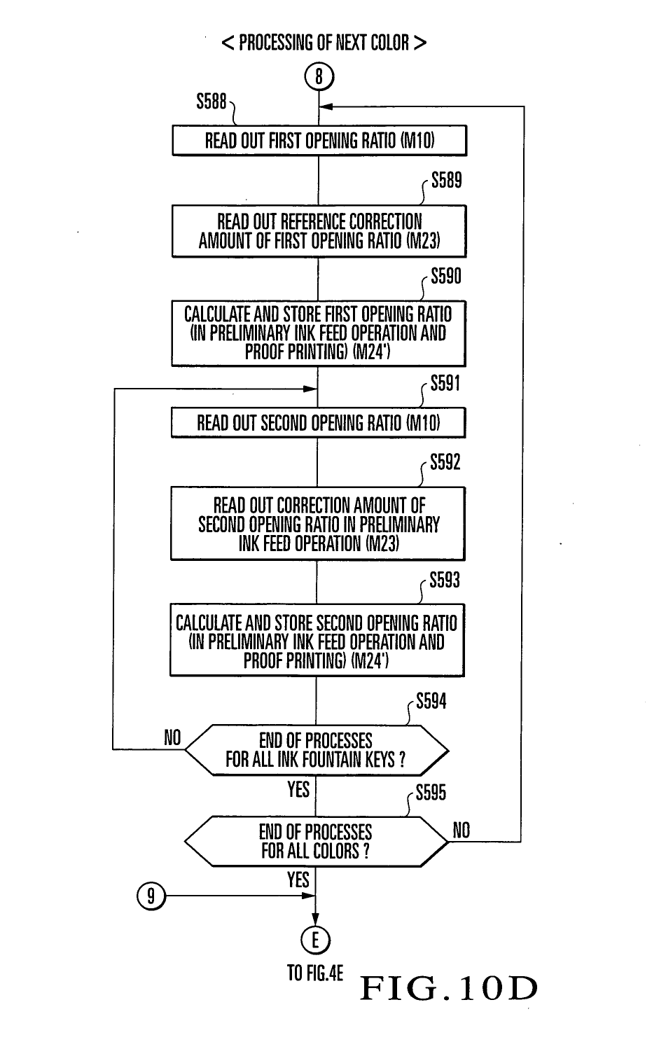

FIGS. 10A to 10E show flowcharts of the second embodiment which are different from those in the first embodiment. Note that the flowcharts other than FIGS. 10A to 10E in the second embodiment are the same as those in the first embodiment. Hence, the flowcharts in FIGS. 4N and 4O are applied, and the description of FIGS. 4A to 4G will be omitted. In the second embodiment, a “proof printing re-preset” process, i.e., the processing contents from step S566 (FIG. 10A) are partially different from those in the first embodiment. The processing from step S566 will be described below.

Similar to the processes in steps S166 to S168, the CPU 10A′ calculates the reference correction amount of the first ink fountain key of the first color, and stores the obtained reference correction amount (steps S566 to S568). The CPU 10A′ reads out, from a memory M21, the measured density difference of the second patch of the first color on a proof printing sample 9′ (step S569). The CPU 10A′ obtains, using the “density difference—correction amount of ink fountain key opening ratio conversion table” of the first color, the reference correction amount of the second ink fountain key opening ratio of the first color on the basis of the measured density difference of the second patch of the first color on the proof printing sample 9′. The obtained reference correction amount is stored in a memory M23 (step S570).

The CPU 10A′ repeats the operations in steps S569 to S571 for the measured density differences of all patches of the first color on the proof printing sample 9′ in the memory M21. Similar to the processes for the first color, the CPU 10A′ obtains the reference correction amounts of the ink fountain key opening ratios for the respective measured density differences of all patches of all colors on the proof printing sample 9′ in the memory M21. The obtained reference correction amount is stored in the memory M23 (FIG. 10B: steps 572 to 579).

[Calculation of Ink Fountain Key Opening Ratio in Preliminary Ink Feed Operation and Proof Printing]

The CPU 10A′ reads out, from a memory M10, the first ink fountain key opening ratio (current opening ratio) of the first color (FIG. 10C: step S580), and then reads out, from the memory M23, the reference correction amount of the first ink fountain key opening amount of the first color (step S581). The reference correction amount of the first ink fountain key opening ratio of the first color is added to the first ink fountain key opening ratio (current opening ratio) of the first color. The obtained value is stored, in the memory M24′, as the first ink fountain key opening ratio of the first color in the preliminary ink feed operation and proof printing (step S582).

The CPU 10A′ reads out, from the memory M10, the second ink fountain key opening ratio (current opening ratio) of the first color (step S583), and reads out, from the memory M23, the reference correction amount of the second ink fountain key opening ratio of the first color (step S584). The reference correction amount of the second ink fountain key opening ratio of the first color is added to the second ink fountain key opening ratio (current opening ratio) of the first color. The obtained value is stored, in the memory M24′, as the second ink fountain key opening ratio of the first color in the preliminary ink feed operation and proof printing (step S585).

The CPU 10A′ repeats the operations in steps S583 to S586 for all ink fountain key opening ratios (current opening ratios) of the first color in the memory M10. Similar to the processes for the first color, the CPU 10A′ adds the reference correction amounts to all ink fountain key opening ratios (current opening ratios) of all colors in the memory M10. The obtained values are stored, in the memory M24′, as the ink fountain opening ratios in the preliminary ink feed operation and proof printing (FIGS. 10C and 10D: steps S587 to S595).

[Adjustment to Opening Ratio in Preliminary Ink Feed Operation and Proof Printing]

When the operations are ended for all colors (YES in step S595), the CPU 10A′ reads out, from a memory M7, the reference rotation amount of the ink fountain roller of each color, and the readout reference rotation amount is transmitted to an ink fountain roller control device 15 of each color. Accordingly, the rotation amount of an ink fountain roller 3 in a printing unit 13 of each color serves as the reference rotation amount (FIG. 4N: steps S228 to S230).

The CPU 10A′ reads out, from the memory M24′, the ink fountain key opening ratio of each color in the preliminary ink feed operation and proof printing. The CPU 10A′ sets the obtained ink fountain key opening ratio of each color in the preliminary ink feed operation and proof printing to the memory M10 and transmits the ink fountain key opening ratio to an ink fountain key control device 16 of each color. The CPU 10A′ then adjusts the opening ratios of ink fountain keys 4-1 to 4-n in the printing unit of each color, into the opening ratios in the preliminary ink feed operation and proof printing (steps S231 to S233).

Upon receiving, from all the ink fountain key control devices 16, the adjustment end signals which represent that the ink fountain key opening ratios are adjusted into the opening ratios in the preliminary ink feed operation and proof printing (YES in step S234), the CPU 10A′ reads out the set speed 2 of the printing press from a memory M12 (step S235), and sets the rotational speed of the printing press to the set speed 2 (high speed) (steps S236 to S239).

The CPU 10A′ transmits the reset signal and enable signal to an internal clock counter 10Q (FIG. 4O: step S240) to start the count operation of the internal clock counter 10Q (step S241). After that, the CPU 10A′ reads out the count value in the first standby time from a memory M27 (step S242), and waits until the count value of the internal clock counter 10Q reaches the count value in the first standby time (steps S243 and S244). For the first standby time, the printing press is kept idle at the set speed 2 (high speed).

[Preliminary Ink Feed Operation]

After the first standby time has elapsed, the CPU 10A′ stops transmitting the enable signal to the internal clock counter 10Q (step S245), and transmits the operation instruction to an ink feed device 14 of each color (step S246). The CPU 10A′ transmits the reset signal and enable signal to a counter 10X for counting the total rotational speed of the printing press (step S247), and starts the count operation of the counter 10X (step S248). Accordingly, the count value of the counter 10X is set to 0, and the ink feed operation of an ink ductor roller 5 is started in the printing unit 13 of each color. That is, in the printing unit 13 of each color, the ink feed operation of an ink ductor roller 5 is started in the state wherein the opening ratios of ink fountain keys 4-1 to 4-n are set to the opening ratios in the preliminary ink feed operation and proof printing without printing.

In the ink feed operation of the ink ductor roller 5 of each color, the CPU 10A′ reads out, from a memory M4, the number of preliminary ink feed operations of the respective colors, and compares the readout value with the count value of the counter 10X (steps S249 to S251). When the count value of the counter 10X equals the number of preliminary ink feed operations of one of colors (YES in step S251), the CPU 10A′ transmits a stop instruction to the ink feed device 14 of the corresponding color (step S252). In a similar way, the operations in steps S249 to S253 are repeated until the count value of the counter 10X equals the number of preliminary ink feed operations of all colors.

If the preliminary ink feed operations are ended in the printing units 13 of all colors (YES in step S253), the CPU 10A′ transmits the reset signal and enable signal to the internal clock counter 10Q (FIG. 10E: step S622) to start the count operation of the internal clock counter 10Q (step S623). The CPU 10A′ then reads out the count value in the second standby time from a memory M28 (step S624), and the printing press is kept idle for the second standby time (steps S625 and S626). After the second standby time (YES in step S626), the CPU 10A′ stops transmission of the enable signal to the internal clock counter 10Q (step S627), and sets the rotational speed of the printing press to the set speed 1 (low speed) (steps S628 to S632).

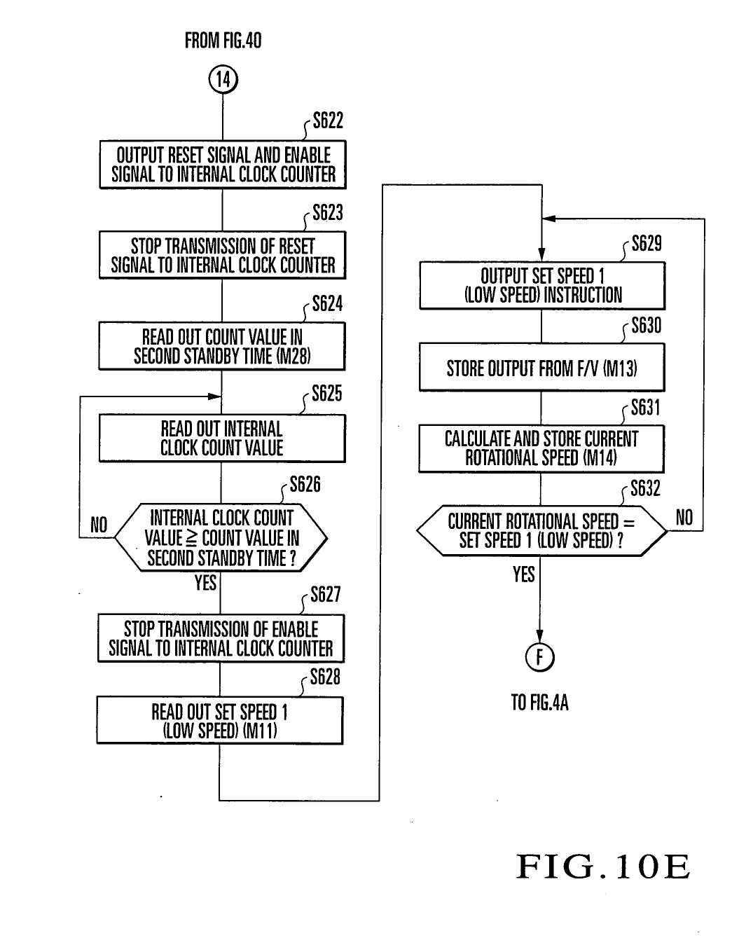

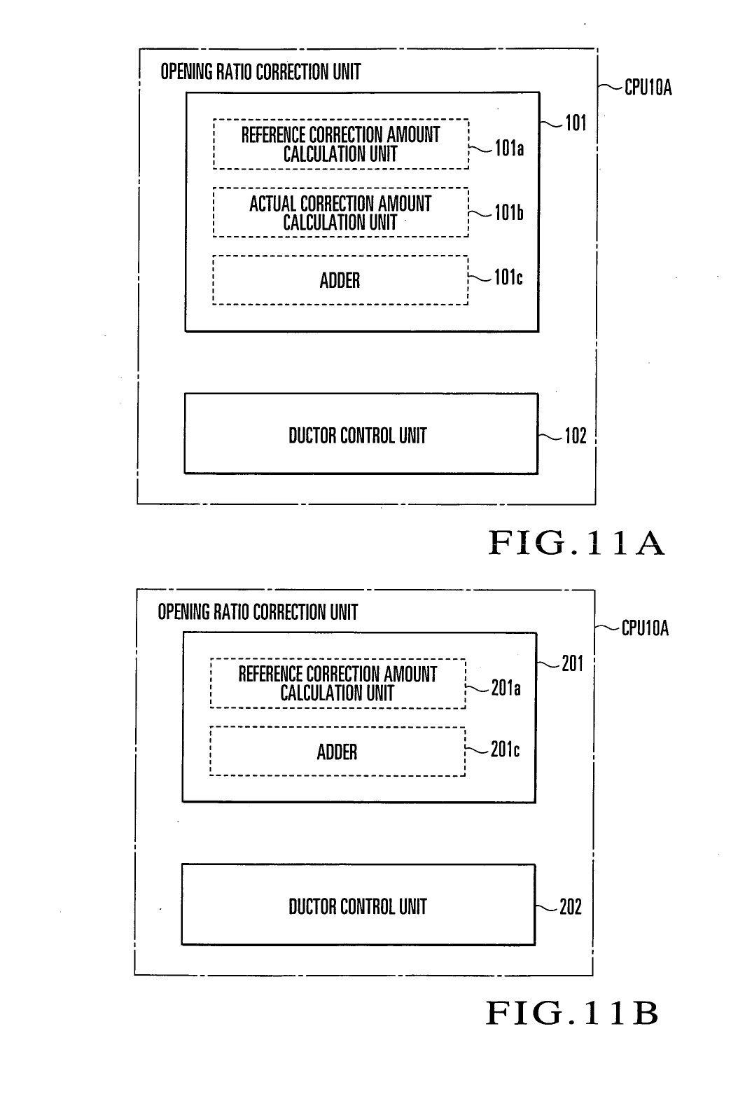

FIGS. 11A and 11B show functional blocks of the CPUs 10A and 10A′ according to the first and second embodiments. Referring to FIG. 11A, The CPU 10A (first embodiment) comprises an opening ratio correction unit 101 (opening ratio correction means) and ink feed control unit 102 (ductor control means). The opening ratio correction unit 101 includes a reference correction amount calculation unit 101a (reference correction amount calculation means) for calculating the reference correction amount of the ink fountain key in the preliminary ink feed operation, an actual correction amount calculation unit 101b (actual correction amount calculation means) for calculating the actual correction amount of the ink fountain key on the basis of a predetermined coefficient and an output from the reference correction amount calculation unit 101a, and an adder 101c (adding means) for adding the output from the actual correction amount calculation unit 101b to the current ink fountain key opening ratio.

The reference correction amount calculation unit 101a executes processes in steps S166 to S168, S174, S175, S183 to S185, S191, and S192. The actual correction amount calculation unit 101b executes processes in steps S169 to S173, S176 to S180, S186 to S190, and S193 to S197. The adder 101c executes processes in steps S203 to S205, S209 to S211, S217 to S220, and S223 to S225. The ink feed control unit 102 executes processes in steps S246 to S253. Note that the adding means may include the adder 101c and ink fountain key control devices 16-1 to 16-n. The ink feed control means may include the ink feed control unit 102 and ink feed devices 14-1 to 14-m.

The actual correction amount calculation unit 101b may calculate the reference correction amount to obtain an actual correction amount having a large absolute value with the same sign.

Referring to FIG. 11B, the CPU 10A′ (second embodiment) includes an opening ratio correction unit 201 (opening ratio correction means) and ink feed control unit 202 (ductor control means). The opening ratio correction unit 201 includes a reference correction amount calculation unit 201a (reference correction amount calculation means) for calculating the reference correction amount of the ink fountain key in the preliminary ink feed operation, and an adder 201c (adding means) for adding the reference correction amount to the current ink fountain key opening ratio as the actual correction amount.

The reference correction amount calculation unit 201a executes processes in steps S566 to S579. The adder 201c executes processes in steps S580 to S595. The ink feed control unit 202 executes processes in steps S246 to S253 (FIG. 40).

In the first and second embodiments, proof printing is exemplified. However, the present invention can be similarly applied to test printing or the like.

Referring to FIG. 12, the inking device in the printing unit of each color of the rotary printing press includes a plurality of ink rollers 6. However, the inking device may include only one ink roller 6.

As described above, the ink feed operation of a ductor roller is performed in a state wherein the ink fountain key opening ratio is corrected without printing. Hence, an amount of ink corresponding to the shortage is supplied to the ink transfer path, and excessive ink is returned from the ink transfer path to the ink fountain, such that the response speed of the print density can be increased when restarting test printing or proof printing. Accordingly, the ink supply amount can be adjusted in a short period of time, and the amount of wasted paper can decrease.

What is claimed is:

1. An ink supply amount adjustment method of a printing press including a plurality of ink fountain keys, an ink fountain roller which adjusts a supply amount of ink supplied from an ink fountain in accordance with an opening ratio of each of the ink fountain keys, and an ink ductor roller which supplies the ink supplied to the ink fountain roller to a printing plate through ink rollers by an ink feed operation, comprising the steps of:
measuring a density value of a printed paper sheet;
correcting the opening ratio of the ink fountain key on the basis of a difference between a measured density value of the printed paper sheet and a preset reference density value; and
performing the ink feed operation of the ink ductor roller without printing after correction of the opening ratio of the ink fountain key to increase or decrease the amount of ink on the ink rollers.

2. A method according to claim 1, wherein the step of performing the ink feed operation comprises the step of adding, to residual ink on the ink rollers, ink supplied from the ink fountain through the ink ductor roller.

3. A method according to claim 1, wherein the step of performing the ink feed operation comprises the step of returning residual ink on the ink rollers into the ink fountain through the ink ductor roller.

4. A method according to claim 1, wherein the step of correcting the opening ratio comprises the steps of
calculating a reference correction amount to set a difference between the measured density value of the printed paper sheet and the preset reference density value to 0, and
adding the calculated reference correction amount as an actual correction amount to a current opening ratio of the ink fountain key.

5. A method according to claim 1, wherein the step of correcting the opening ratio comprises the steps of
calculating a reference correction amount to set a difference between the measured density value of the printed paper sheet and the preset reference density value to 0,
calculating, from the calculated reference correction amount, an actual correction amount having a larger absolute value with the same sign, and
adding the calculated actual correction amount to a current opening ratio of the ink fountain key.

6. A method according to claim 1, wherein the step of correcting the opening ratio comprises the steps of
calculating a reference correction amount to set a difference between the measured density value of the printed paper sheet and the preset reference density value to 0,
calculating an actual correction amount by multiplying the calculated reference correction amount by a predetermined coefficient, and
adding the calculated actual correction amount to a current opening ratio of the ink fountain key.

7. A method according to claim 6, wherein the step of calculating the actual correction amount comprises the step of calculating an actual correction amount by multiplying the reference correction amount by a coefficient larger than 1.

8. A method according to claim 1, further comprising the step of performing proof printing after the ink feed operation of the ink ductor roller.

9. An ink supply amount adjustment apparatus of a printing press including a plurality of ink fountain keys, an ink fountain roller which adjusts a supply amount of ink supplied from an ink fountain in accordance with an opening ratio of each of the ink fountain keys, and an ink ductor roller which supplies the ink supplied to the ink fountain roller to a printing plate through ink rollers by an ink feed operation, comprising:
density value measurement means for measuring a density value of a printed paper sheet;
opening ratio correction means for correcting the opening ratio of the ink fountain key on the basis of a difference between a measured density value of the printed paper sheet and a preset reference density value; and
ink feed control means for performing the ink feed operation of the ink ductor roller without printing after correction of the opening ratio of the ink fountain key to increase or decrease the amount of ink on the ink rollers.

10. An apparatus according to claim 9, wherein said ink feed control means adds, to residual ink on the ink rollers, ink supplied from the ink fountain through the ink ductor roller.

11. An apparatus according to claim 9, wherein said ink feed control means returns residual ink on the ink rollers into the ink fountain through the ink ductor roller.

12. An apparatus according to claim 9, wherein said opening ratio correction means comprises
reference correction amount calculation means for calculating a reference correction amount to set a difference between the measured density value of the printed paper sheet and the preset reference density value to 0, and
adding means for adding the reference correction amount calculated by said reference correction amount calculation means, as an actual correction amount to a current opening ratio of the ink fountain key.

13. An apparatus according to claim 9, wherein said opening ratio correction means comprises
reference correction amount calculation means for calculating a reference correction amount to set a difference between the measured density value of the printed paper sheet and the preset reference density value to 0,
actual correction amount calculation means for calculating, from the reference correction amount calculated by said reference correction amount calculation means, an actual correction amount having a larger absolute value with the same sign, and
adding means for adding the actual correction amount calculated by said actual correction amount calculation means, to a current opening ratio of the ink fountain key.

14. An apparatus according to claim 9, wherein said opening ratio correction means comprises
reference correction amount calculation means for calculating a reference correction amount to set a difference between the measured density value of the printed paper sheet and the preset reference density value to 0,
actual correction amount calculation means for calculating an actual correction amount by multiplying the reference correction amount calculated by said reference correction amount calculation means by a predetermined coefficient, and
adding means for adding the actual correction amount calculated by said actual correction amount calculation means, to a current opening ratio of the ink fountain key.

15. An apparatus according to claim 14, wherein a coefficient to be multiplied by the reference correction amount is larger than 1.

16. An apparatus according to claim 9, wherein proof printing is performed after the ink feed operation of the ink ductor roller.
